(19) United States
(12) Patent Application Publication
(10) Pub. No.: US 2025/0218610 A1
(43) Pub. Date: Jul. 3, 2025

(54) Nano-Engineered Materials for LENR

(71) Applicant: Klee M. Irwin, Topanga, CA (US)

(72) Inventor: Klee M. Irwin, Topanga, CA (US)

(21) Appl. No.: 19/053,731

(22) Filed: Feb. 14, 2025

Related U.S. Application Data
(63) Continuation of application No. 18/422,434, filed on Jan. 25, 2024, now abandoned.
Application No. 18/422,434 is a continuation of application No. 17/511,761, filed on Oct. 27, 2021, now abandoned.
Application No. 17/511,761 is a continuation of application No. 16/116,687, filed on Aug. 29, 2018, now abandoned.
(60) Provisional application No. 62/552,097, filed on Aug. 30, 2017.

(51) Int. Cl. G21B 3/00; B82Y 30/00

(52) U.S. Cl. CPC G21B 3/002; B82Y 30/00

(57) ABSTRACT

Nanoengineered materials are disclosed for Low Energy Nuclear Reactions (LENRs). The nanoengineered materials include quasicrystals and quasicrystal approximants. The energy landscape of these materials is designed to increase a tunneling probability of atoms that participate in a fusion reaction. The nanoengineered materials are designed to have arrangements of atoms in which there are active sites in the material for LENR. The active sites may include networks of double wells designed into the material. In some examples, the design also limits the degrees of freedom for atoms in ways that increase a tunneling probability for tunneling of atoms into sites where fusion occurs.

### CROSS-REFERENCE TO RELATED APPLICATIONS

This application is a continuation of U.S. application Ser. No. 18/422,434, entitled “Nano-Engineered Materials for LENR”, filed Jan. 25, 2024, which is a continuation of U.S. application Ser. No. 17/511,761, entitled “Nano-Engineered Materials for LENR”, filed Oct. 27, 2021, which is a continuation of U.S. application Ser. No. 16/116,687, entitled “Nano-Engineered Materials for LENR”, filed Aug. 29, 2018, which claims priority under 35 USC § 119 (e) to U.S. Application No. 62/552,097, entitled “Nano-Engineered Quasicrystalline Materials for LENR,” filed Aug. 30, 2017, the entirety of which are herein incorporated by reference.

### TECHNICAL FIELD

Embodiments of the disclosure are generally related to the nanoengineering of materials to have active sites for Low Energy Nuclear Reactions (LENR). More particularly, embodiments of the disclosure are directed to quasi-crystal and quasi-crystalline approximant materials nanoengineered to have active sites for LENR designed into the energy structure created by the arrangement of atoms in the quasicrystal or quasicrystalline approximant materials.

### BACKGROUND

Low Energy Nuclear Reactions (LENRs) have been experimentally confirmed by researchers at several U.S. government labs and by several universities in the United States and abroad. These include results reported by US Navy researchers, teams at MIT, NASA, SANDIA, China Lake, SRI, and hundreds of other university groups and corporations.

The LENR literature includes a vast number of published reports of successful experiments that have reported detection of post-experiment transmutation products resulting from nuclear fusion between metallic and gaseous atoms and between gaseous and gaseous atoms respectively.

One of the current explanations for the LENR in the research literature is that it relies on occasional, sparse defects within metallic lattices. In this “sparse defect” model, the defects are highly localized regions that have a local energy structure, different than the bulk material, that allows LENR to occur. These defects are sparse, in the sense that they have a low density. The defects are also not uniformly distributed and are difficult to reproducibly create.

In the sparse defect model, LENRs ordinarily occur only in isolated microscopic regions of a metal that are called “hot spots.” Edmund Storms calls these small regions nuclear active environments (NAEs). These are active sites where LENRs are energetically favorable.

Various explanations have been provided in the research literature for what these sparse defects might be. Storms has proposed that the defects are a special form of micro-cracks, although other explanations for the nature of these sparse hot spots have been proposed. Thus, as illustrated in FIG. 1A, according to this interpretation a palladium metal lattice without microcrack defects may not have LENR. However, in some circumstances, such, as illustrated in FIG. 1B, microcrack defects may form that are energetically different than the bulk metal lattice in which there are NAEs.

An implication of the sparse defect model is that there is some exotic energy landscape in the defect region in which the probability of fusion reactions is exponentially greater than in the bulk palladium metal lattice.

The sparse defect model explains why the heat production can be so variable in different LENR experiments. In some situations, defects, probably micro-cracks, form in the material and create localized active sites that are energetically favorable toward LENR. But the LENR literatures does not suggest any technique to reproducibly create such defects, let alone a high density of such defects.

Thus, while LENR has been experimentally demonstrated, the prior art does not provide any solutions for how a bulk material could be intentionally engineered to have a reproducibly high density of active sites for LENR.

Embodiments of the disclosure were developed in view of the above-described problems.

### SUMMARY

Nanoengineered materials are disclosed for use in LENR based on quasicrystals or quasicrystalline approximants. The nanoengineered materials are designed with an arrangement of atoms that creates an energy landscape selected to achieve a high tunneling probability of metal atoms (e.g., Pd) and hydrogen isotopes (e.g., deuterium) loaded into the nanoengineered material.

Quasicrystals are a special phase of matter. A quasicrystal is a quasiperiodic structure that is ordered but lacks translational symmetry. A quasicrystal approximant is a state of matter in which “local” regions having quasicrystal symmetry are embedded within a larger crystal.

In one embodiment, the quasicrystal is designed to have a structure having energy wells distributed throughout the volume of the material that favors LENR. In one embodiment, this includes major energy wells for a heavy atom, such as Pd, to tunnel to. In one embodiment, minor energy wells are formed to “load” hydrogen isotope atoms (e.g., deuterium) proximate deep energy wells.

In one embodiment, the particular arrangement of major and minor energy wells may be selected to support LENRs throughout a volume of the quasicrystal and to optimize tunneling probabilities for LENR to occur.

In one embodiment, the minor energy wells are shallower interstitial sites between quasiperiodically arranged groups of metal atoms, such as palladium atoms. In one embodiment, the system forms of major and minor wells forms in in local icosahedral symmetric deformations of ordinary metallic lattice sites.

In one embodiment, the nanoengineered material is based on quasicrystalline clathrate based quasicrystalline approximant phason systems.

In one embodiment, the nanoengineering material is designed to have restricted but nonzero degrees of freedom that favor tunneling.

In one embodiment, the nanoengineered materials are configured to include a restriction on a degree of freedom for atomic tunneling including at least one of a spatial restraint, a temporal restraint, and an orientation restraint on degrees of freedom. The at least one restraint on a degree of freedom may be selected to increase an atomic tunneling probability for LENR. In one embodiment, the restriction on the degrees of freedom is selected to achieve an atomic tunneling probability approximating one.

In one embodiment, the restriction on the degree of freedom is selected to maximize a negentropy.

In one embodiment, a quasicrystal is designed to maximize negentropy. In one embodiment, the quasicrystal is a zeolite substrate quasicrystalline approximant clathrate having a negentropy at a maximum possible level.

In one embodiment, the nanoengineered material has an energy well structure with deep energy wells that approximate Dirac delta functions. Atomic tunneling is favored in systems with massively restricted but non-zero degrees of freedom. The restriction on the degrees of freedom results in what might be called “probability lensing” in the sense of favoring atomic tunneling. The most extreme example of this notion of “probability lensing” is a physical approximation of the ideal Dirac delta function double well potential known as a one-dimensional (1D) quasicrystal phason.

In one embodiment, the nanoengineered materials form three dimensional (3D) networks of double well potentials in which atoms hop back and forth as phasons via tunneling. In one embodiment, palladium (Pa) tunnels to the other end of a deep double well potential.

In one embodiment, over the time domain, a highly restricted non-zero level of freedom leads to high tunneling probability, i.e., high amplitude, acting as a quasiperiodic anharmonic oscillator.

In one embodiment, the nanoengineered materials are configured to support tautomeric tunneling.

In one embodiment, the nanoengineered material permits LENR to occur throughout a large number of energy wells designed into the quasicrystal/quasicrystalline approximant energy well structure throughout a bulk volume of the quasicrystal/quasicrystalline approximant nanoengineered materials. Consequently, the LENRs can be more homogeneously distributed over the volume of the material and also more reproducible than materials relying on sparse “defects” in bulk metal lattices to create LENR hot spots.

In some embodiments, the nanoengineering materials improves the tunneling probabilities for more than one kind of LENR, such as heavy atom+light atom LENR and light-atom+light atom LENR. In some examples, this includes Palladium-dueterium fusion and deuterium-deuterium fusion reactions.

In one embodiment, the quasicrystal or quasicrystalline approximant has a calthrate structure in which a “guest” nano-cluster is disposed with a host “cage.” In one embodiment, trapped guest clusters have a different symmetry than the host to limit the degrees of freedom. In one embodiment, the number of orientations of a guest cluster is limited to a number of orientations selected to approximate a double well potential.

In one embodiment, the guest nano-cluster may comprise a comparatively heavy atom capable of having a LENR with a hydrogen isotope, such as deuterium. In one embodiment, the guest structure has a first symmetry and the host has a different symmetry such that the guest possesses more than one lowest energy configuration. In one embodiment, guest host clathrate systems are engineered with tautomeric (dynamic) icosahedrally symmetric guest clusters trapped in cubic symmetry host cages, or vice-versa.

In one embodiment, the nanoengineered material is designed to close the gaps in packings of sub-clusters of five and 20 tetrahedra. The tunneling tautomeric particles trapped in cages form clathrate guest-host systems. In one embodiment, a special rotation angle explains the appearance of five and 20 Face Centered Cubic (FCC) sub-clusters in the organization of pentagonally and icosahedrally symmetric superclusters. In one embodiment, when this cluster is placed in a magnetic trap, it can oscillate via tunneling at low energy in tautomeric high-speed fashion. The source of oscillation energy is believed to be the zero-point field.

In one embodiment, specific tetrahedral packings and golden ratios may be utilized in the geometry of the quasicrystal. In one embodiment, the density of the population of clathrate guest host cells in a given volume of materials in increased by selecting aspects of the packing, such as growing the FCC based golden ratio twisted tunneling nano-clusters inside electromagnetic (EM) traps that suspend and segregate the clusters so that they can oscillate feely.

In one embodiment, the guest nano cluster comprises palladium. The fabrication of the nano-engineered material may include selecting the material composition, selecting and selecting the time/temperature quenching cycle to permit large cell cages to grow and segregate and trap dynamic tautomeric tunneling clusters of palladium atoms in a quasicrystal or quasicrystalline approximant.

In one embodiment, clusters of FCC metallic lattice elements, such as Pd, are organized as 20 tetrahedral packings to form an icosahedrally symmetric supercluster. This cluster is trapped in a crystal cell (such as Na-zeolite Y) to form a tunneling tautomeric clathrate system. The addition of deuterium causes Pd+D fusion as the Pd atoms tunnel between the two coordinates of their deep narrow double well potentials. A secondary D+D, D+D+D . . . class of reactions occurs with even higher frequency, as the D atoms tunnel to the energy wells vacated by the tunneling Pd atoms. In one embodiment, the overall system is defined by and self-organizes as a result of specific dipolar orientations of the constituent particles. These orientations are different than the orientations in an ordinary crystal or an amorphous structure and may be selected to allow for special magnitudes and ratios of quantum wave function resonance and tunneling that potentiate tunneling.

In one embodiment, the nanoengineered materials may be designed to have an energy well structure, of major and minor energy wells, that favors LENR in a variety of different ways. This includes designing an energy well structure that favors tunneling of heavy atoms that participate in heavy-atom/light atom LENR. For example, the energy well structure may favor a Pd atom tunneling onto a site of an energetic well occupied by a hydrogen atom, resulting in a first type of LENR. However, the minor energy wells may also be designed to favor tunneling of light atoms (e.g., deuterium) for light atom-light atom LENR. For example, when a deep energy well become vacant (by a Pd atom tunneling to another site), two or more nearby deuterium in shallow wells may tunnel into that deep energy well site, resulting into a second type of LENR.

In one embodiment, the tunneling probability leading to LENR between atoms is improved by relating the quantum mechanical wave function by special magnitudes and ratios of resonance and damping. One way to manipulate the resonance and damping of the quantum wave functions of two particles is to adjust their relative dipolar orientations. In one embodiment, this is achieved by the engineering of the energetic landscape of traps and double wells around the two oscillators.

In one embodiment, models are presented, based on quasicrystal theory and principles of quantum gravity, as useful engineering models to explain aspects of designing the nanoengineered materials to improve tunneling probabilities for LENR. In one example, a theory for the mechanism of action of low energy nuclear reactions (cold fusion) is presented. Atoms, such as palladium, are organized into approximations of ideal Dirac delta function (δ function) double well potentials tunnel with exponentially higher than ordinary probability, as compared to their tunneling probability in amorphous and crystalline atomic motifs. A dynamical 3D network of such double well potentials can be nanoengineered as quasicrystals and quasicrystalline approximants.

In one embodiment, gaseous atoms, such as deuterium, are loaded into the fabricated nanoengineered material to “contaminate” the vacant halves of this 3D system of double wells without exponentially lowering the quantum mechanical tunneling probability of the heavier atoms to the vacancy sites. This results in frequent atomic tunneling of the heavier atoms to coordinates within the mutual Coulomb radii of the heavy and light atoms, allowing fusion to occur without the energy required in hot fusion reactions. A secondary and more frequent form of fusion occurs in this system. Prior to tunneling, the heavier atoms prevent symmetric arrays of lighter atoms, each an equal distance from a given heavy atom, from tunneling to the bottom of the energy well by the heavy atom. When the heavy atoms tunnel to their vacancy sites, two or more of these light atoms, such as deuterium, tunnel with high probability to the energy well vacated by the heavier atom. In this exotic system, D+D, D+D+D . . . fusion occurs with high frequency.

In one embodiment, the nanoengineering relies on quasi-crystallographic concepts, clathrate theory and an understanding of tautomeric isomers based on a tautomeric model for small atomic clusters.

In one embodiment, the nanoengineering material is fabricated based on general principles of quasicrystal and quasicrystal approximant fabrication. A quasicrystal structure is designed, based on principles of materials science and physics, to have desired attributes, such as a desired energy landscape or other attributes. Growth and fabrication of the desired design of the nanoengineered material is then be performed by selecting the composition of major materials and dopants and selecting a time/temperature cycling to “quench” in a phase of matter having the desired materials structure (i.e., the designed quasicrystal or quasicrystalline approximant structure). Alternatively, in one embodiment, a semi-empirical technique is used for the fabrication. For example, a quasicrystal or quasicrystalline approximant structure for LENR may be empirically determined by testing different candidate materials and fabrication techniques.

In one embodiment, the fabricated nanoengineered material is formed into a power generating cell that is placed into a chamber. The chamber permits a pressured light atomic gas (e.g., a hydrogen isotope gas such as deuterium) to enter the chamber and load the nanoengineered material. A heat exchanger or heat extractor may be provided to extract generated heat from an exothermic LENR. The pressure of the light atomic gas may be selected as an operating parameter to favor LENR.

In addition to LENR applications, the nanoengineered materials are also useful for storing hydrogen and hydrogen isotopes, such as deuterium. Consequently, in some embodiments, the nanoengineered materials have additional uses and applications as a hydrogen storage medium. In one embodiment, deuterium is loaded into the nanoengineered material.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1A illustrates a bulk metal lattice and FIG. 1B illustrates defects forming active sites (NAEs) for LENR.

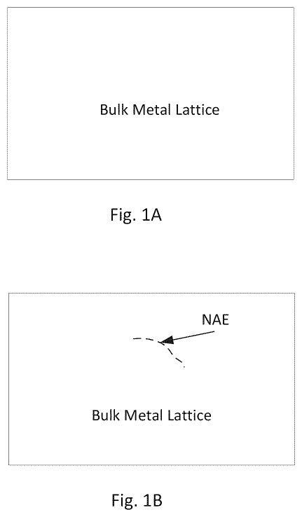

FIG. 2 illustrates a nanoengineered materials based on quasicrystal or quasicrystalline approximant materials having LENR active sites designed into the energy landscape of the material in accordance with an embodiment.

FIG. 3 is a flowchart illustrating a method of designing, fabricating, and using materials nanoengineered for LENR in accordance with an embodiment.

FIG. 4 shows an example of a double well potential at two different times to illustrate tunneling of Pd and deuterium in accordance with an example.

FIG. 5 illustrates a particle changing coordinates by integer multiples of the Planck length in different time frames in a set of 7 squares in accordance with an example.

FIG. 6 illustrates the particle changing coordinates but with the “X” representing energetic barriers to tunneling limiting the freedom of the particle to move in the 7-square diagram from A to B in accordance with an example.

FIG. 7 illustrates gaps between tetrahedral units in accordance with an example.

FIG. 8 illustrates tetrahedra arranged in (a) icosahedral symmetry and (b) after rotation in accordance with an example.

FIG. 9 illustrates rapid oscillation between the right (A) and left (C) twisted 20-groups forming an illusionary superposition shape that is a non-chiral and icosahedrally symmetric object (B) in accordance with an example.

FIG. 10 illustrates a metallic cluster of four spheres inscribed by a regular tetrahedron in accordance with an example.

FIG. 11 illustrates an example of 80 spheres divided into 20 groups of four spheres, each circumscribed by a tetrahedron, with FIG. 8 illustrating both left and right chirality.

FIG. 12 illustrates the right and left chirality configurations of FIG. 11 without the tetrahedral boundaries shown in accordance with an example.

FIG. 13 illustrates application of the golden ratio associated angle to close the face-to-face gaps in a group of five tetrahedra.

FIG. 14 illustrates projection of five tetrahedra with face to face rotations of ArcCos[(3φ−1)/4]° with second image adding the yellow convex hull around the projection in accordance with an example.

FIG. 15 illustrates the yellow convex hull from FIG. 14 around the image of five tetrahedral clusters of FCC packed atoms in accordance with an example.

FIG. 16 is an electron microscope image of 20 FCC clusters of large numbers of palladium atoms, each in a tetrahedral form. On the right, is a close up of one of the 12 pentagonal cones in the cluster and the superposition of the right and left 20-group shown in FIG. 6.

FIG. 17 illustrates the 20 group is five sets of four tetrahedra, where the outer vertices of each set form the vertices of a cuboctahedron in accordance with an example.

FIG. 18 illustrates twenty evenly spaced regular tetrahedra sharing a common vertex at the center in accordance with an example.

FIG. 19 illustrates an evenly spaced 20-group and the left chirality 20-group after application of the special golden ratio based rotation in accordance with an example.

FIG. 20 illustrates an icosahedron inscribed in an octahedral cage at the “A” orientation with a potential to flip to the “B” orientation in accordance with an example.

FIG. 21 illustrates a one dimensional energy landscape, wherein the darkly shared circles represent atoms occupying energy wells and where the atom with the “X” has its lowest energy state at well “A” or “B” and can tunnel between the two locations in accordance with an example.

FIG. 22 illustrates the 3:1 inclusion complex of urea and 1, 6-dichlorohexane in accordance with an example.

FIG. 23 illustrates a Tsai-type quasicrystal and approximant that consists of a five-shell structure, wherein the four outer shells have icosahedral symmetry and the inner cluster has tetrahedral symmetry that can rapidly change orientation between several different equally low energy orientations in accordance with an example.

FIG. 24 illustrates a 20-group particle in the center surrounded by two layers of its empire in accordance with an example.

FIG. 25 illustrates matching trit selection states, shown in yellow, where the empires of the red and blue 20-groups (centers) have overlapping and paired needs in which they can share the yellow tetrahedra in accordance with an example.

FIG. 26 illustrates the anti-paired case, where the overlap I in conflict (as indicated by the oval) and where the two empires do not share tetrahedra of the same chirality at the overlapping regions in accordance with an example.

FIG. 27 illustrate a comparison of the long-range potential strength for the Yukawa and Coulomb potential illustrating how the Coulomb potential has an effect over a greater distance and where the Yukawa potential approaches zero quickly in accordance with an example.

FIG. 28 illustrates an image of the 80-group of atoms, where each group of four kissing atoms are not kissing other groups of four in accordance with an example.

### DETAILED DESCRIPTION

### Introduction

Embodiments are disclosed in this patent application of nanoengineered materials for low energy nuclear reaction (LENR). The application includes a list of references at the end, which are cited throughout the text in an analogous fashion to footnotes by using numbers within brackets to refer to specific references in the list of references (e.g. [Reference 42] referring to reference number in the list of references at the end of the specification), with it being understood that each of the references is incorporated by reference.

The nanoengineered materials include quasicrystals or quasicrystalline approximants in which the design of the materials structure is selected such that the arrangement of atoms creates an energy landscape that forms nuclear active sites for LENR. In particular, the design of the nanoengineered material is chosen to favor (increase the likelihood) of atomic tunneling of LENR reactants to nuclear active sites in the nanoengineered material.

A variety of properties of quasicrystals and quasicrystalline approximants permits the energy structure to be engineered for LENR. This includes mechanisms for atomic rearrangements via phasons, which are quasiparticles existing in quasicrystals due to the quasiperiodic lattice structure in quasicrystals. Moreover, some quasicrystal and quasicrysalline approximant materials permit materials to be designed with advantageous arrangements of atoms. In other words, because quasicrystals and quasicrystalline approximants are an exotic class of materials, they open up new opportunities to create nanoengineered materials specifically designed for LENR.

Quasicrystals are a special phase of matter that was discovered in the 1980s. A quasicrystal is a quasiperiodic structure that is ordered but lacks translational symmetry. A quasicrystal approximant is a state of matter in which “local” regions having quasicrystal symmetry are embedded within a larger crystal. It is a periodic version of a quasicrystal in which the same atomic clusters are packed periodically. The substructures or the structural tiles of approximants are the same as those of the corresponding quasicrystals but are arranged periodically in approximants whereas a true quasiperiodic arrangement is observed in quasicrystals. In other words, approximants reproduce within their unit cells a portion of the aperiodic structure. Approximants often have large lattice parameters in the directions in which the corresponding quasicrystal is quasiperiodic.

Quasicrystals and quasicrystalline approximants are a relatively new class of materials that provide new opportunities to nanoengineer materials for LENR. Specifically, the arrangement of atoms, designed into the quasicrystal or quasicrystalline approximant structure, may be selected to have an energy structure that favors the tunneling of atoms into sites where LENR occurs.

In a power cell, the nanoengineered materials are loaded with a light gaseous element, such as hydrogen. For example, in one embodiment, in a power cell, the nanoengineered materials are loaded with a hydrogen isotype, such as deuterium, and used to generate excess heat. This excess heat may be used for a variety of purposes, including electric power generation.

Throughout this patent application, the example of palladium and hydrogen isotopes (e.g. deuterium) as the metallic and gaseous atoms is used. However, it will be understood that these are merely examples for illustrating principles of nanoengineering materials for LENR and that embodiments of this disclosure are not necessarily limited to only these examples.

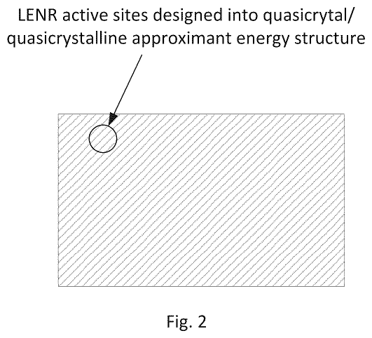

FIG. 2 is a figure illustrating that the design of the atomic arrangement of atoms in the quasicrystal or quasicrystalline approximant creates an energy landscape with active sites for LENR distributed throughout the nanoengineered material. Thus, while the examples below illustrate a small portion of the material corresponding to individual active sites for LENR, at a global level there are sites for LENR distributed throughout the materials caused by the specific design of the material.

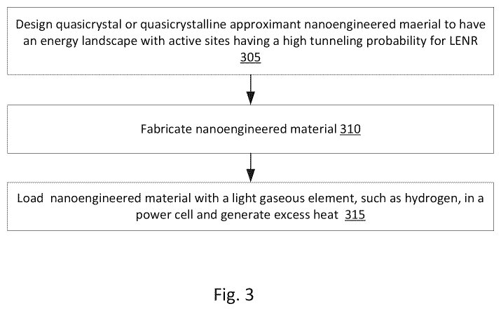

As illustrated in the flow chart of FIG. 3, a quasicrytal or quasicrystalline approximant material is designed to have an energy landscape with active sites having a high tunneling probability for LENR in block 305. As described below in more detail, the energy landscape may include approximations of double-well potentials, restrictions on a degree of freedom, and other factors that favor atomic tunneling for LENR. The designed material is fabricated in block 310. The fabricated material is used in a power cell to generate excess heat in block 315. For example, the fabricated material may be placed in a power cell and loaded with a light gaseous element, such as hydrogen to generate excess heat. As an example, the light gaseous element may be a hydrogen isotope gas such as Deuterium.

The discussion below provides example of specific nanoengineered materials, although it will be understood that general classes of materials are contemplated such that the invention is not to be limited to the specific examples described below. Some general and more specific examples of physical mechanisms for LENR are described, with the more general examples being provided for illustrative purposes and the different mechanisms being provided to illustrate design principles that may be employed to design the materials structure.

### Overview of Quasicrystal and Quasicrystalline Approximant LENR, Phasons, and Quantum Gravity

A quasicrystal or quasicrystalline approximant material has an arrangement and ordering of the atoms in its structure that creates energy wells. This might be called the “energy landscape.” For example, in a quasicrystal with heavy atoms (e.g., palladium), this will result in a quasiperiodic arrangement of energy wells. The quasiperiodic arrangement of energy wells may be designed to have high atomic tunneling probabilities that favor LENR.

Throughout this document, we use the example of palladium and deuterium as the metallic and gaseous atoms that are the LENR reaction components. However, the mechanism of action applies to various combinations of larger atoms with the addition of gaseous atoms loaded into the nanoengineered material.

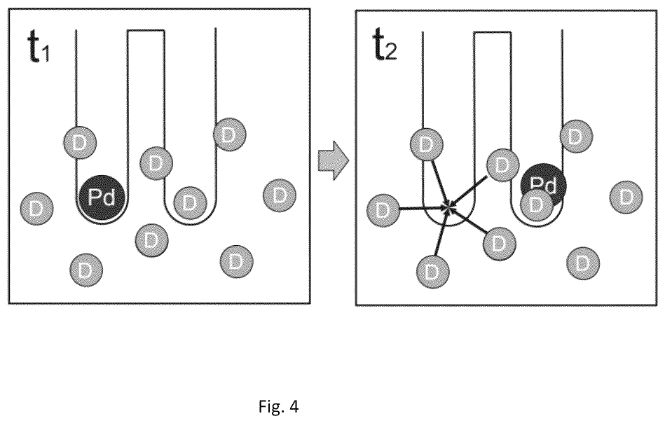

FIG. 4 illustrates some aspects of palladium (Pd) tunneling in a double well potential structure in a portion of a quasicrystal or quasicrystalline approximant material. There is a double well potential in the sense that there are two energy wells (a first energy well and a second energy well) close enough to each other for atomic tunneling to occur. The arrangement of atoms designed into the material creates the deep double well potential, which also occurs in other portions of the material. At any given time, some fraction of individual deep wells may be vacant of Pd atoms. The Pd tunnels to the vacant half of the double well potential that is occupied by the D atom. The tunneling causes two or more D atoms around the first energy well to tunnel to approximately the same coordinate at the bottom of the vacated energy well.

At some time t1, in this portion of the material, one of the deep wells has a Pd atom and the other nearby deep well is vacant of Pd.

The first energy well on the left is illustrated at time t1 as having a Pd atom in it. In this example, the second energy well on the right has a deuterium atom (D) in it. The D in the second energy well was attracted there because of the deep energy well. However, because D has a low atomic mass/charge (compared with Pd) the presence of the D in the second energy well does not significantly reduce the depth of the second energy well.

Note that at time t1 there are also D atoms in nearby locations outside the deep double well. For example, the material structure may have a design selected for there to also be minor (i.e., energetically shallow) wells for the D atoms.

At time t2, the Pd atom tunnels from the first energy well to the vacant (second) energy well on the right that is occupied by a D atom. This results in the palladium sometimes fusing with deuterium.

At time t2, secondary D+D, D+D+D . . . fusion reactions occur when the tunneling palladium instantly vacates the first energy well. When the Pd vacates the first energy well, it creating a high potential for two or more deuterium atoms to tunnel to the newly vacated deep energy well (in this example, the first energy well).

Deuterium can be loaded into metallic palladium at a 4:1 atomic ratio [Reference22]. Accordingly, where double well potentials for palladium exist, there is a high likelihood that deuterium will “contaminate” the vacant halves of the double well. Globally, the system can be nanoengineered as a quasiperiodic palladium deuteride (as a quasicrystal or quasicrystalline approximant), wherein the deuterium atoms aperiodically self-organize at the minor and major energy wells defined as follows:
1) The major energy wells are defined as the phason-hopping sites of palladium. These are deep and narrow double well potentials.
2) The minor wells are the much shallower interstitial sites between quasiperiodically arranged groups of palladium atoms that the deuterium atoms nest in.

When a palladium atom tunnels to the other end of its deep double well potential, the deuterium atoms adjacent to it then jump or “trade-up” to the more energetically attractive deeper energy well just vacated by the heavier palladium atom. This type of system forms in local icosahedrally symmetric deformations of ordinary metallic lattice sites.

For higher density energy output, guest-host clathrate systems can be engineered, wherein tautomeric (dynamic) icosahedrally symmetric guest clusters are trapped in cubic symmetry host cages (or vice versa).

A quasiperiodic palladium deuteride or a palladium deuteride quasicrystalline approximant will possess at least a 4:1 deuterium to palladium ratio because they are less dense than the periodic crystalline form of palladium.

In these examples, these structures are three-dimensional (3D) networks of double well potentials, where atoms hop back and forth, as phasons, via tunneling. As shown in FIG. 3 at t2, the instant tunneling of a palladium atom leaves an array of two or more deuterium atoms equidistant from the bottom of the vacated energy well. And, as mentioned, the major wells are significantly deeper than the minor energy wells that most of the deuterium reside in. Accordingly, two or more deuterium atoms will tunnel to the vacated well and fuse.

Here we have a Pd+D and a D+D or D+D+D . . . model for LENR. Pd+D fusion events will be less probable due to the presence of the deuterium atoms in the vacant energy wells, which lowers the quantum mechanical probability for palladium tunneling.

The diagram of FIG. 4 showing Pd+D fusion and D+D, D+D+D . . . fusion is physically true even if the geometry of the diagram is simplified for purposes of illustration. In other words, quantum mechanics allows for some probability that the atoms tunnel and fuse in the manner suggested.

The question is not if tunneling occurs that results in fusion. The issue is using the special properties of quasicrystal or quasicrystalline approximate material to design materials having a high tunneling atomic tunneling probability for LENR to occur.

For example, the ordinary probability for a palladium atom (in a conventional volume of ordinary metallic palladium) to tunnel a full angstrom away in some moment is very low, less than 10⁻¹⁰⁰ which is virtually impossible. The conventional explanation for LENR in a volume of ordinary metallic palladium is that sparse defects are where LENR occurs in ordinary metallic palladium. That is, the real-world LENR data suggests that the sparse defect regions are regions in which the quantum mechanical tunneling probabilities are high compared with ordinary metallic palladium. That is, the energy structure in the sparse defect regions is a different energy landscape than the bulk metallic palladium in some way that increases the tunneling probability to be high enough for LENR to occur.

However, quasicrystal and quasicrystalline approximant materials have exotic energy structures. This permits them to be intentionally nanoengineered to have an arrangement of atoms selected to achieve a high tunneling probability compared with ordinary metallic palladium.

In one embodiment, principles of quasicrystal theory, quantum gravity, and particle physics are used to identify special conditions within which a tunneling probability for LENR is exponentially increased (compared with conventional materials) for a quasicrystal or quasicrystalline approximant throughout the volume of the material.

There is a mathematical formalism for a quasicrystalline geometry. A change of connections on a point space is called a phason flip. This correlates to a length, the Planck length. And energy is phason flips bound in matter or EM radiation, while mass is the price “charged” by a particle to change its ratio of clock cycles to forward propagation or its direction. The price charged is in phason flip units.

This mathematical formulism can be explained using concepts from quantum gravity. The search for a quantum gravity theory can be thought of as going “all the way” with the principle of quantizing. Interestingly, Werner Heisenberg, who introduced the first formalism for quantum mechanics before Schrodinger, believed nature was “pixilated” (quantized) to the core, not just in terms of particle properties, such as spin, light (photons) and action [25]. That is, he felt space and time are also quantized. However, in the 1920s, the notion of reality being pixilated was simply too bizarre. Today, quantum gravity research programs take Heisenberg's idea of space and time pixelation seriously. Emergence theory has also been proposed as an approach to consider space to come in discrete building block units at the Planck scale.

Any change of a physical system, i.e., motion, can be viewed as be an ordered set of two or more frozen graph theoretic configurations of a Planck scale aperiodic point space. In this view, the apparent invariance of the speed of light and Lorentz invariance can be resolved using a discretized version of the de Broglie-Bohm electron clock model for massive particles.

Answering that question explains aspects of a model of LENR in quasicrystals and quasicrystalline approximants in an intuitive way, using standard quantum mechanical formalism. It provides an explanation how designing the energy landscape change the atomic tunneling probability from being very low to being very high (e.g., the tunneling probability of an atom can go from well over 10⁻¹⁰⁰ to (approximately) 1 in certain exotic energy landscapes.

There are different interpretations of quantum mechanics. However, in the case of quasicrystals and quasicrystalline approximants, we can use an interpretation of quantum mechanics in which there is quantized space and time. The evidence favors an interpretation of quantum mechanics in which there is quantized space and time. Space is quantized based on a Planck length and time is quantized based on a Planck time. In this interpretation, an atom travels between two locations based on multiples of a Planck length over multiples of a Planck time. There is no continuous movement in space and time. At first blush, it would seem this is a philosophical choice for a scientist to make between two equally plausible possibilities. It is true there is no direct physical evidence for quantized space and time. Experimental test equipment cannot resolve anywhere close to the Planck length and Planck time. On the other hand, there is no direct evidence for smooth space and time.

Another way to state it is that it is valid, scientifically, to assume discrete space and time in some of our models. It is valid interpretation, which in turn is useful, in various ways, to arrive at models for designing some aspects of the nanoengineered materials for LENR.

This is one of the aspects of designing real-world devices based on quantum mechanics. Different interpretations of quantum mechanics are theoretically possible. However, some interpretations of quantum mechanics are more useful in particular materials design contexts—and may also further have more indirect experimental evidence behind them, particularly in certain materials design contexts. Thus, in some of the following analysis, an interpretation of quantum mechanics with quantized space and time is used.

In particular, atomic tunneling may be validly interpreted using a model with quantized space and time. Scientific equipment cannot detect the difference between a model that postulates particles changing from an A to B coordinate smoothly by traveling through an infinite number of coordinates between A and B or via a step-wise model of discrete frozen frames. When an atom in a phason flip is experimentally observed in a quasicrystal, it is not measured to smoothly travel from A to B. Only discrete coordinates at each measurement are registered in the equipment. We see only coordinates A and B over two measurements. However, where there is an energetic landscape that makes it virtually impossible for the atom to exist between locations A and B at some low temperature, we label this event “quantum tunneling.” Many physicists explain tunneling as something like a quantum leap in an electron orbital change, wherein it never smoothly travels through the infinity of coordinates between radii A and B. This view is analogous to the notion of teleportation in science fiction movies. In another words, it is completely valid and there is indirect experimental data to support the concept that notions of discrete space and time can be applied to understanding atomic tunneling in a quasicrystal.

In a power cell, the nanoengineered materials are loaded with a hydrogen isotype, such as deuterium, and used to generate excess heat. This excess heat may be used for a variety of purposes, including electric power generation. In one embodiment, a LENR optimization model can be called a quasicrystalline approximant or a clathrate system with an icosahedral guest cluster. Such systems of double well potentials are self-perpetuating. They are an exotic special class of atomic organization, where anharmonically driven tunneling events occur.

If we assume quantized space and time it allows for a simple explanation of how the atomic tunneling probability may be dramatically increased in a quasicrystal/quasicrystalline approximant.

Note that atomic tunneling in double well potentials that approximate the Dirac function is true even assuming continuous space and time. However, some aspects of atomic tunneling in double well structures can be best understood using notions of discrete space and time.

We will now discuss in more detail the notion of what tunneling is in the logical framework of quantized space and time. In one embodiment, the foundational essence of this model for LENR is that it is driven by atomic tunneling in 3D networks of 1D quasicrystals that are themselves strings of double well potentials as physical approximations of the Dirac delta function (δ function). That is, the energetic landscape of the quasiperiodic structure has deep energy wells that approximate Dirac delta functions.

The Dirac delta function formalism is discretized into a Planck scale Dirichlet integer based quasi-lattice of two lengths at the Planck scale having a ratio of 1 to the inverse of the golden ratio, and where the sum of those two fundamental lengths is the Planck length. However, the Dirac delta formalism does not require such discretization of space since the potential is zero everywhere except for the vacancy site at the other end of a very deep and narrow double well potential that takes an infinite value.

The essence of the idea is what we call “tunneling probability lensing” and can be defined thusly: the restriction of the degrees of freedom over space and/or time of an oscillator increases the rate of tunneling (i.e., the rate of tunneling is exponentially larger than ordinary integer multiples of the Planck length coordinate change from A to B during two sequential frames of discrete time or change).

Accordingly, in the section below discuss both spatial and temporal non-zero restriction of degrees of freedom.

### A. Atomic Tunneling Increase Via Spatial Restriction of Degrees of Freedom

Many interesting aspects of atomic tunneling behavior can be understood based on an interpretation of quantum mechanics with discrete space and time. This corresponds to the teleportation view of tunneling. When a particle changes from coordinate A to B, where such coordinates are on a discretized point space, it must do so with some integer multiple of frozen frames of change from coordinate A to coordinate A+n, A+m . . . , as analogized by how change on a video monitor corresponds to two or more frozen selection states of pixels on the screen.

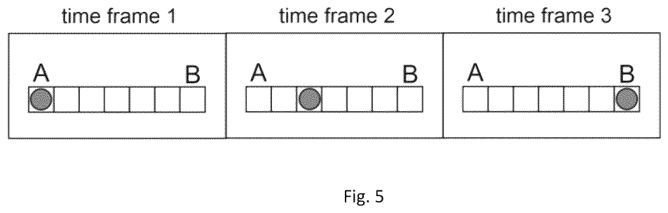

FIG. 5 illustrates a particle changing coordinated by integer multiples of the Planck length. For example, in the diagram of FIG. 5, a particle instantly changes coordinate by two Planck lengths in frame 2 and by four in frame 3.

We can now extend the model in the 7-square diagram of FIG. 5 to a physically realistic case. A typical tunneling hop in a low temperature quasicrystal phason is at the angstrom scale. That is about 1025 pixels or Planck lengths. Let us flatten the 1D energy landscape such that it is not a double well potential. Again, we consider all movement to be an ordered sequence of two or more frozen frames, wherein discrete coordinate changes (each an integer multiple of the Planck length) occur in each frame. There is essentially a 100% probability that the particle will change coordinate soon after frame 1. And if we have 1025 possible coordinates that it can discretely hop or “tunnel” to along the angstrom of length, there is an exponentially low probability of it tunneling to any particular coordinate within the selection of 1025 that are possible.

Accordingly, quantum mechanical formalism gives a probability for tunneling in a homogeneous energy space to a given coordinate as being virtually zero-nearly impossible. Because the homogeneous energy landscape provides no differentials to lens or concentrate probabilities onto a few coordinates, the only factor is the energetic landscape generated by the particle itself. For example, if it were an electron, the self-interaction with its own field would be the only meaningful information that plugs into the quantum formalism, which would result in the probability of the electron tunneling to coordinates near its origin being higher than to coordinates farther away. Accordingly, the electron will discretely hop small distances in each Planck moment, simulating a model of virtually smooth motion through space.

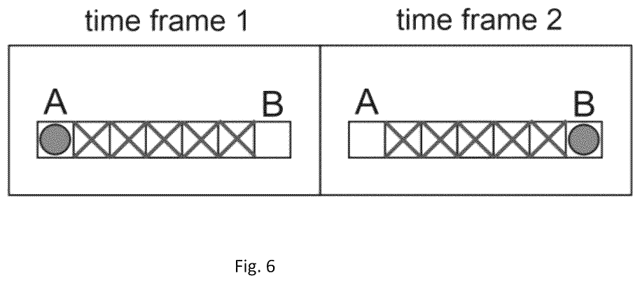

However, the energy landscape can be engineered to inhibit the probability for the particle to tunnel to any of the 1025 coordinates other than the B coordinate a full angstrom away, we “lens” or concentrate the tunneling probabilities that were formerly “smeared out” or distributed over a large number of coordinates onto just the one coordinate. In other words, we create a real-world approximation of the ideal Dirac delta double well potential. The diagram of FIG. 6 shows this in the case of the 7-square example, where the Xs are massive energetic barriers exponentially lowering the tunneling probability to those discretized coordinates.

The 1D system is now a very deep and narrow double well potential. The quintessential example of these extremely restrictive systems in nature are in quasicrystals, where 1D, 2D or 3D networks of double well potentials form. For example, an icosahedrally symmetric quasicrystal is an atom-sharing network of 1D aperiodic atomic strings—1D quasicrystals. By electromagnetically blocking a particle from tunneling to a large number of discrete coordinates, we exponentially increase the probability of tunneling to the un-blocked coordinates-probability lensing. The maximum possible non-zero restriction is the exponential reduction to just one “escape route” shy of an ideal EM trap or system of EM traps known as a crystal (virtually zero degrees of freedom). That is, instead of zero freedom, we allow only one degree of long range freedom (where “long range” refers to angstrom scale). With such exponentially reduced freedom, the statistical probability for tunneling to the energetically free locations is itself exponentially increased, generally from a number larger than 10⁻¹⁰⁰ to about 1.

### B. Atomic Tunneling Increase Via Orientation Restriction Degrees of Freedom

Another form of spatial restriction, the relative orientation of particle spin and electric and magnetic dipole, is known to exponentially potentiate quantum tunneling [Reference 31]. The application of this to quasicrystals and quasicrystalline approximants will be discussed later in the section Geometry and Quantum Mechanics.

### C. Atomic Tunneling Increase Via Temporal Restriction of Degrees of Freedom

Another class of restriction of freedom that drives tunneling probability is temporal restriction. The limit of spatial restriction of an oscillator is an ideal electromagnetic trap, where the particle must remain at the same coordinate over two or more discrete frames of change/time. The physically real analogue (a crystal lattice) allows only low amplitude oscillation about a small radius from the bottom of the energy well in the lattice or other EM trap where the particle is nested. Conversely, the ideal upper limit on spatial freedom is nearly infinite vectorial degrees of freedom, as can be approximated in models for the degrees of freedom of gaseous or amorphous aggregates of particles.

As stated, the ideal non-zero limit of a spatial oscillator is the Dirac delta function. The physical analogue is a very deep and narrow double well potential approximating the Dirac delta, as can be found in quasicrystalline and clathrate based quasicrystalline approximant phason systems. Analogously, the limit of temporal restriction of an oscillator is the periodic frequency of an ordinary harmonic oscillator, where there is only one possible beat interval-zero choice or freedom. The upper limit on temporal freedom in a discretized spacetime model is an oscillator that is free to change coordinates at any point in discretized Planck time and to arbitrarily change the integer multiple of such Planck time increments over some number of discrete coordinate changes. Trivially, high temporal freedom in a system of oscillators is noisy with high entropy. The temporal analogue of the non-zero spatial limit of a deep narrow double well potential is a special class of anharmonic oscillators made of two temporal intervals. In other words, a beat of one frequency has zero freedom of choosing timing intervals. But a non-random pattern of two frequencies is the maximally restrictive but non-zero case. For example, a Fibonacci beat follows the beat timing correlated to a Fibonacci chain 1D quasicrystal, where the long length in the quasicrystal is replaced by a long beat interval and the short length is replaced by a short interval and the ratio between the two is the golden ratio.

In an actual quasicrystal or quasicrystal approximant, the tunneling of phason hopping atoms can occur in complete synchrony because a dynamic 3D quasicrystal is a time and space coordinated interactive network of Dirichlet integer spaced double well potentials, i.e., a network 1D quasicrystals. When one atom tunnels to another energy well, it changes the energy landscape of the rest of the system and causes coordinated phason flips throughout the 3D network. Tsai et al. reported resonant synchronized orientation changes among thousands of tetrahedral guest clusters in the Tsai type quasicrystalline approximants at low temperature [Reference 32]. Each orientation change of a tetrahedral cluster is composed of single atoms tunneling between golden ratio based A-B coordinates along short 1D paths. These paths are defined in part by the energetically allowed dipole orientations and coordinates of the atoms in the tetrahedral clusters that are inscribed in the dodecahedral cages of the Tsai type approximant unit cells.

Tunneling probability is also increased in anharmonic systems due to the time-periodic driving of the potential wells induced by the non-linear dynamic phenomena that drive the anharmonic time-restrictive oscillations. In particular, the driving amplitude in quasicrystals induced by phasons is very large compared to ordinary less restrictive localized anharmonic vibrations.

In the universe of non-chaotic anharmonic oscillators, most cases include a nearly infinite set of possible individual beat spacings, as compared to the massively restrictive but non-zero case of the two allowed beat spaces in a Fibonacci beat anharmonic oscillator. However, the Fibonacci beat spacing is the maximally restrictive case. There can be tribonacci beats, composed of three temporal choices, and so on.

A quasicrystal can be defined as an aperiodic pure point spectrum [Reference 36]. The general pattern can exist over the time domain as a classic quasicrystal or over the time domain as a beat quasicrystal. Logically, the two systems correspond to one another such that beat quasicrystals are the coordinated and restrictive anharmonic timing of oscillations of spatial quasicrystals. The more restrictive the allowed intervals are, the larger the integer multiple of Planck lengths there are in given a tunneling event of an oscillator. However, when restriction is so great that there is no choice, there is zero freedom. Accordingly, the greater the non-zero restriction of freedom of an oscillator over the time and/or spatial domains, the greater its amplitude-its integer multiple of Planck lengths in a coordinate change from one Planck moment to the next in a double well oscillator's A and B coordinates.

This contribution to tunneling probability via non-zero restriction over the time domain will be further developed below regarding how quantum mechanics dictates an exponential increase in tunneling probability when the relative dipole orientations of the wave functions of two oscillators are oriented in a very specific manner such that a particular “sweet spot” of resonance to damping of the interacting wave functions yields a high tunneling probability (e.g., approximating 1)

### Tautomeric Tunneling

As previously discussed, while there are many different possible theoretical interpretations of quantum mechanics [Reference 37], [Reference 38], an interpretation in which there is quantized space and time is theoretically supported and also supported by substantial empirical evidence. Additionally, an interpretation of quantum mechanics in which there is quantized space and time can be further extended to include the notion that complimentarity or superposition of the positions of particles in their quantum wave form can be replaced, in principle, by the notion of literal sequences of positions that are so fast one cannot measure sequential coordinates. Again, quantum mechanics has many possible interpretations, and for a particular design problem we are permitted to choose the interpretation of quantum mechanics that works best for solving a particular problem, consistent with any known empirical data. This includes, at least in some situations, assuming that the concept of quantum mechanical superposition can be replaced by other quantum mechanical interpretations consistent with real world evidence.

For example, the term “superposition” is so widely assumed to be to be the only valid interpretation for many problems in quantum mechanics to those not familiar with the rigorous mathematical development of de Broglie's pilot wave idea [Reference 39].

Just as we are logical to conjecture that motion through space occurs in discrete frozen frames in integer multiples of the Planck length, we may agree that an oscillation of a particle between locations A and B at the Planck time of 1044 times per second is virtually equivalent to the notion of “superposition.” Tautomeric isomers oscillate between two or more symmetrically equivalent atomic configurations faster than our equipment can detect. What does show up in our spectral data corresponds to an illusionary mirage shape with sharp peaks that is actually an average or superposition of the full permutation cycle of the symmetrically identical tautomeric atomic bond and coordinate configurations. Particles in these systems are known to tunnel [Reference 40].

For example, DNA is a quasicrystal, as predicted by Schrodinger in 1949 [Reference 41] (“aperiodic crystal”) prior to the precise identification of the molecule by Crick and Watson [Reference 42]. Each of the two DNA strands is a 5-periodic helix with the two strands offset along the shared helical axis by two sequential Fibonacci numbers approximating the golden ratio. DNA has rotational symmetry but not translational symmetry-one of the defining characteristics of quasicrystals. Put differently, the DNA molecule is a 3D network of deep and narrow double well potentials allowed by golden ratio based atomic organization. Spontaneous mutation of DNA is known to occur when a proton tunnels [Reference 43].

A double well potential exists along a hydrogen bond that is separated by an energy barrier. One of the two wells is deeper than the other so the proton has a higher probability to reside in the deeper well. But a meaningful probability still exists for tunneling to the shallower well, wherein mutation occurs. This is called a tautomeric transition [References 44, 45].

As mentioned, a tautomer is a system of atoms that rapidly fluctuates between two geometric configurations. In many cases, the oscillation is so fast that we cannot see either configuration individually with our experimental probing devices. So we detect an average or blur between the two geometries, which is third geometry that never actually exists physically. The dynamical object that is depicted is the average shape in our models (while acknowledging that the real two or more shapes are hidden from view). Bullvalene is an example.

An article by James Anson, “One for all and all for one; shape-shifting organic molecules that spontaneously resolve,” said [Reference 46]:

Bullvalene is an intriguing molecule. A small polycycle with 10 carbons and 10 hydrogens, and an unusual property: it has no permanent chemical structure. Its bonds are constantly rearranging through a seemingly endless series of Cope rearrangements. It's estimated that there are over 1.2 million possible valence tautomers, and due to the rapidity of the conversions, all carbons and protons appear as equivalent on the NMR timescale.

In other words, the shape changes so fast that one cannot measure individual configurations with nuclear magnetic resonance spectroscopy. A quote from Advances in Quantum Chemistry says of Bullvalene [Reference 47]: “ . . . the interconversions are so fast that the corresponding NMR spectrum consists of a single, sharp band.”

In Molecular Complexes in Earth's Planetary, Cometary and Interstellar Atmospheres, Vigasin and Slanina state [Reference 48]:

When a molecular structure possesses geometric symmetry, there may be more than one equivalent version of it on the potential energy surface. In essence, an element of symmetry relates two or more identical nuclei . . . . Different versions of a structure arise when distinct labels are attached to atoms of the same element so that more than one unique (non-superimposable) labeling of the structure becomes possible. The existence of several versions of a structure (although physically indistinguishable from one another) becomes apparent when motions between them occur on the timescale of observation.

In other words, many people label the cluster of atoms as having a shape that is the average or superposition of two more shapes or orientations. Only when we have equipment that can measure the individual shapes can we see them. So instead, the shape is depicted as the average of the changing shapes in order to discuss what the dynamical object is. They continue by saying these special dynamical molecules work via atomic tunneling:

. . . the quantum mechanical picture [of fluxional clusters] is of tunneling between versions [shape or orientation permutations]. Wave functions for the different versions [permutations] penetrate the barriers between them, mix and cause splittings at of the levels which are localized in each well. Transitions between such sets of split levels now themselves appear to be split or perturbed. So-called interconversion tunneling has been observed in the vibrational and rotational spectra of many molecules . . . .

The Wikipedia page for bullvalene says [Reference 49]: “ . . . in this molecule the Cope rearrangement takes place even at −110° C., a temperature at which this type of reaction is ordinarily not possible.”

Zhang et al. showed how quantum mechanics allows bullvalene to tunnel at very rapid speed at cryogenic temperatures [Reference 50].

The superpositions of tautomeric tunneling molecules serve as an analogy for how the notion of complimentarity or superposition of the positions of particles in their quantum wave form can be replaced, in principle, by the notion of literal sequences of positions that are so fast one cannot measure sequential coordinates.

Another conjecture or interpretation widely assumed to be true but not required by the mathematics of quantum formalism is the idea of “randomness.” Most physicists today presume randomness is at the core of nature because the conjecture is taught in a manner that implies there is actual evidence for it. However, experiments in no way indicate randomness. For example, in the Stern-Gerlach experiment [Reference 51], there is a 50% probability that a particle will be measured as being, say, spin up. But the pattern of data over thousands of sequential measurements shows no order. It looks random. Some have naively suggested this as evidence that nature is inherently random. However, if we assume spacetime is discrete, where change occurs at a very fast “framerate,” our timing of sequential measurements would not select evenly measured increments of a fast non-random sequence. That is, we would introduce randomness into the data due to poor timing precision with which we perform rapid sequences of measurements. Our fastest ability to measure today is at 1018 times per second [Reference 52]. The fastest possible frame rate of a quantum gravity or discrete spacetime view of fundamental physics would be the Planck time, 1044 times per second. A slow sampling rate of a very fast but orderly sequence ensures that arbitrary or non-equal increments of temporal spacing of measurements of the fast process. In other words, arbitrary and uneven multiples of the fast sequence will be captured by the slower pulse of the laser in the measuring apparatus. Accordingly, the technological limitation of the experiment introduces a random pattern into the sequence of measurements—the data.

A rapid oscillation between two or more distinct configurations and/or orientations can thus be modeled as a superposition, even though no superposition exists physically. A plausible alternative idea with deep implications for quantum computing theory is that superposition is not real. It is instead an oscillation between two or more possible configurations that occur in discrete intervals—a frame-based view of quantum gravity. The logical fundamental frequency acting as the underlying beat of inverse harmonics as integer multiples of that base pulse for some system of massive oscillators is the Planck time or 1044 frames per second. Such a fast frame rate would naturally appear to be smooth to us, just as water was conjected to be a smooth continuous substance until experiment and theory showed it was pixilated at the scale of H2O molecules. If a quantum computer based on small cluster particle physics could tap into the 1044 per second frame rate—the Planck time “CPU speed” of the universe—it could solve exponentially complex computations, such as large number factorizations, remarkably fast. Well established quantum models, like the Dirac sea and the notion of zero point energy [Reference 53] fluctuations at the fabric of spacetime (experimentally predicted via Casimir force [Reference 54] experiments using dual metal plates), make the notion of ultra-fast dynamism of such fluxional systems plausible. Another example of a physical phenomenon many consider real but that cannot be measured is the light-speed frequency of the zitterbewegung [Reference 55] motion of fundamental particles.

Tautomeric systems are known to occur via simultaneous quantum tunneling of entire groups of atoms. In 2016, Kolesnikov et al. showed how entire H2O molecules tunnel with high frequency in special freedom-restricted configurations [Reference 56]. The fundamental decomposition helpful to understand why the quantum probabilities are so high in these systems is the model of 3D networks of deep narrow double well potentials as physical analogues of the ideal Dirac delta double well. Icosahedrally symmetric Quasicrystals are the quintessential example of such 3D networks. Dolinšek et al. said: “NMR experiments on an icosahedral . . . quasicrystal have detected slow atomic motions in the sub-kHz range at temperatures between 0.16 and 130 K. The observed motion is limited in space and can be associated with local phason fluctuations at very low energies, involving quantum tunneling at very low temperatures.”

### A Tautomeric Tunneling Model for Small Atomic Clusters

Small atomic clusters behave anomalously. That is, the older scientific literatures does not have complete models that accurately predict their behavior. Kostko et al. [Reference 24] discussed how a clear predictive model of the shape and behavior for small atomic clusters is lacking:

Furthermore there are many indications that the cluster geometries have a decisive influence on their melting behavior; an unambiguous determination of these structures, however, has yet to be done.

One clue to what might be physically real is that small clusters have icosahedral symmetry. Another clue is that they are built of sub-clusters of atoms arranged in the face centered cubic (FCC) configuration. The most popular models are the Mackay icosahedron and icosahedrally symmetric multiple twinned FCC superclusters [Reference 79]. Although these models are the best available, they do not correspond well to experimental data.

Oxford cluster specialist, Jonathan Doye, says [Reference 80]:

When a cluster's interactions can be described by a pair potential the main contribution to the energy comes from nearest neighbors. Therefore, one might expect those structures with the greatest number of nearest-neighbor contacts to be lowest in energy. This would favor structures, such as the Mackay icosahedron, which are both spherical and have {111} surface facets [FCC crystal]. However, there is another factor. In icosahedra and decahedra, the structures must be strained in order to eliminate the gaps that result if the structures are composed of regular tetrahedra (see below). There is an energetic penalty associated with this strain.

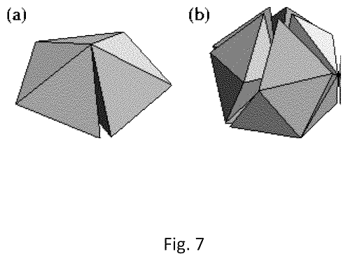

FIG. 7 illustrates gaps between tetrahedral units. Examples of the strain involved in packing tetrahedra. (a) Five regular tetrahedra sharing a common edge leave a gap of 7.36 degrees. (b) Twenty regular tetrahedra sharing a common vertex leave gaps amounting to a solid angle of 1.54 steradians.

In 2005, Baletto and Ferrando were not the first to make statements like the following one about small clusters of atoms [Reference 81]:

An icosahedron can be thought of as composed of 20 FCC tetrahedra sharing a common vertex . . . . When 20 regular tetrahedra are packed around a common vertex, large interstices remain. To fill these spaces, the tetrahedra must be distorted, thus generating a huge strain on the structure. Inter-shell distances are compressed, while intra-shell distances are expanded.

It is important to note that the speculation of tetrahedral sub-cluster distortion by Baletto and Ferrando and many others is a conjecture, albeit a logical one. There simply is little choice but to presume the five FCC substructures of the pentagonal and the 20 FCC subparts of the icosahedral supercluster are distorted, although NMR data cannot provide direct evidence for this because the distortion necessary is subtle.

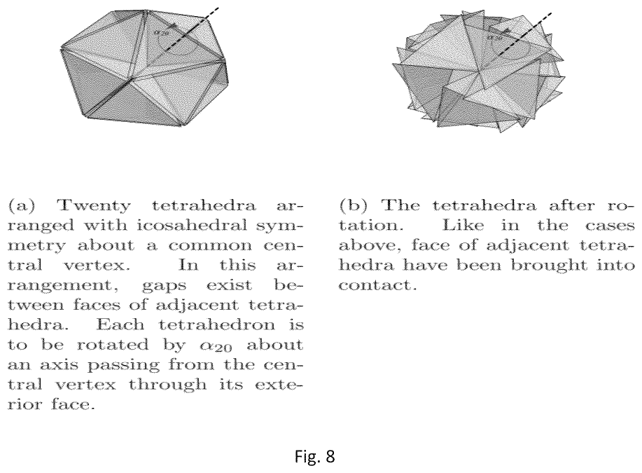

In 2013, the inventor's research group (Quantum Gravity Research) reported a novel solution that causes tetrahedral faces to kiss in packings of 5 and 20 tetrahedra [Reference 82]. As shown in the FIG. 8, we rotate each tetrahedron by ½ [ArcCos (−½)−ArcCos (¼)]. This is the only rotation that causes faces to kiss. The cluster comes in right and left-chirality versions, depending on the direction of the rotation. FIG. 8 illustrates tetrahedra arranged in (a) icosahedral symmetry and (b) after rotation.

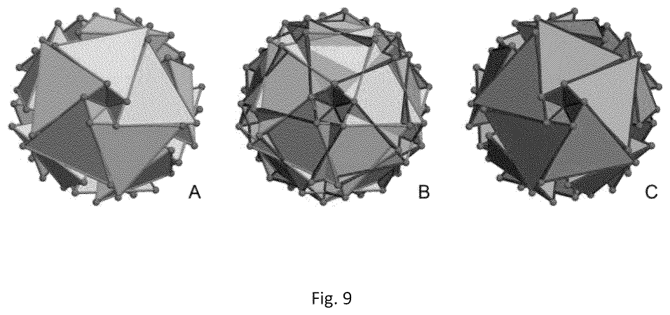

In FIG. 9, we see that the rapid oscillation between the right (A) and left (C) twisted 20-groups forms an illusionary superposition shape—a non-chiral and icosahedrally symmetric object (B).

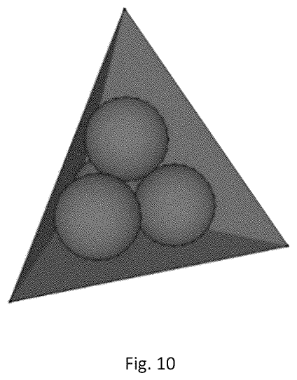

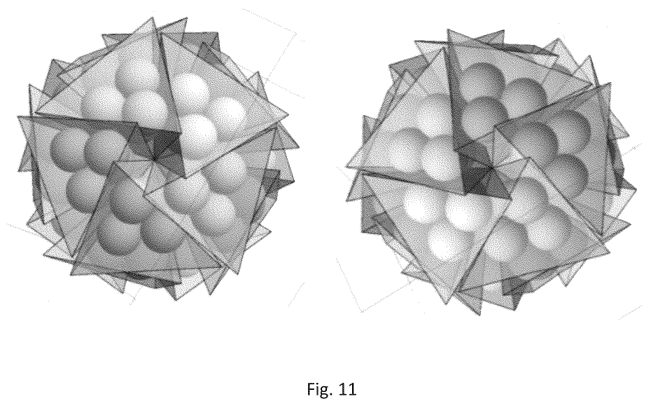

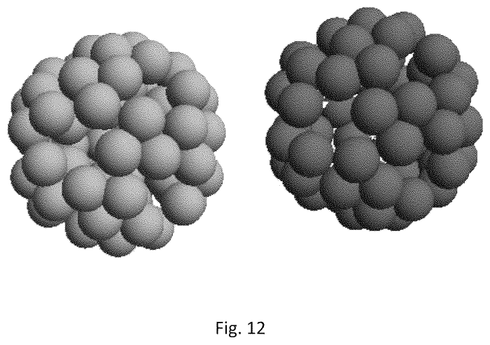

FIG. 10 is an illustration of a metallic cluster of four palladium atoms inscribed in a regular tetrahedron. FIG. 11 shows a right and left twisted group of 20 tetrahedral metallic “chunks” of the FCC configuration, with each tetrahedral container circumscribing four atoms/spheres. Both left and right chirality configurations are shown. FIG. 11 illustrates the right and left chirality configurations of FIG. 12 without the tetrahedral boundaries illustrated. The tautomeric action between the right and left mirror permutations requires virtually no energy and occurs at a rate too rapid to distinguish from one another. What would appear in the NMR data is a non-chiral illusionary superposition shape, as shown. This phenomenon of superposition of two or more shapes in ultra-fast tautomers and other isomers is well established experimentally [Reference 83].

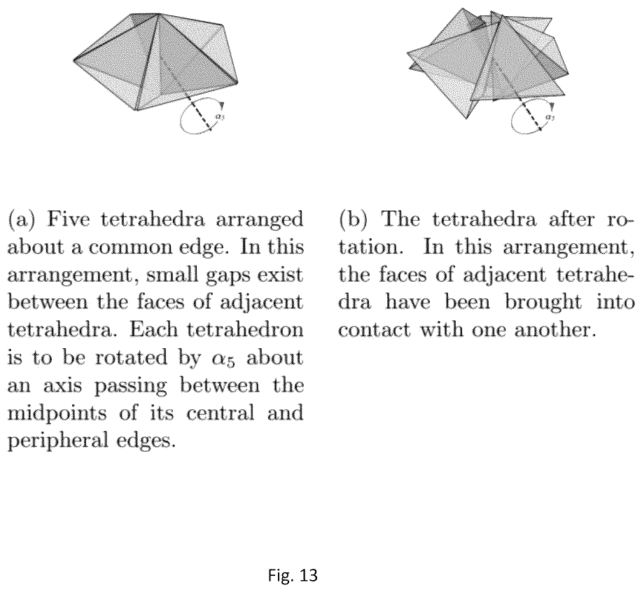

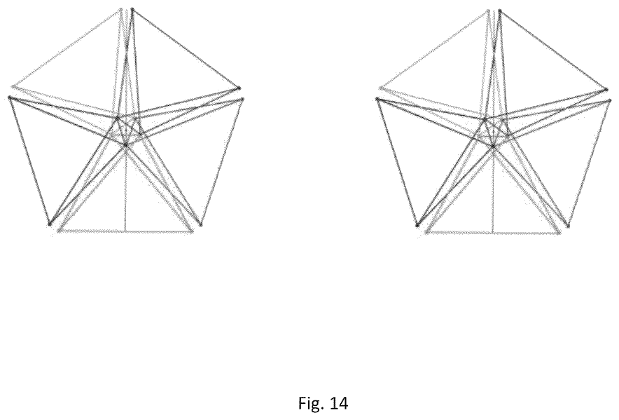

The left and right alternating rotations of the 80-group cluster form a rotamer, which is a form of stereoisomer called a conformational isomer. The inner faces of the tetrahedra are rotated from one another by ArcCos[(3φ−1)/4], where φ is the golden ratio. This same angle applied to the face-to-face rotation of a group of five tetrahedra results in the chiral face-kissing structure of FIG. 13. FIG. 14 shows an application of the golden ratio associated angle to close the face-to-face gaps in a group of five tetrahedra.

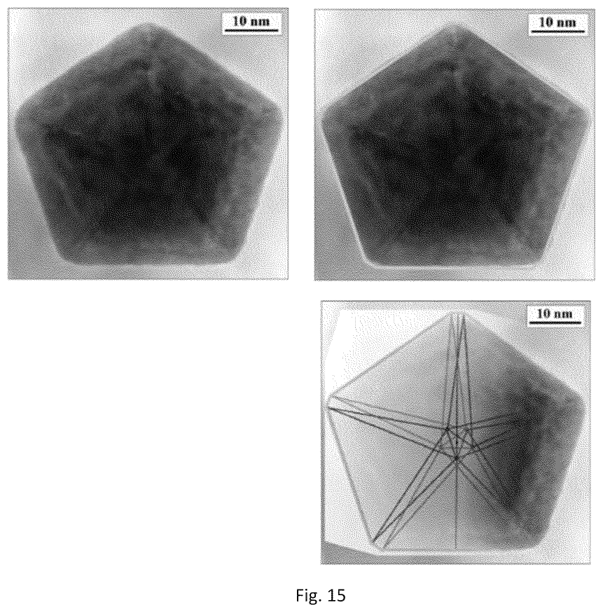

FIG. 15 is a projection of this 5-tetrahedron twist [left] with the 2D convex hull of its right-left superposition circumscribing it [right]. The left image in FIG. 15 is from a paper by Hofmeister, Fivefold Twinned Nanoparticles [Reference 84]. It shows a super cluster of palladium atoms composed of five separate tetrahedral subsystems in FCC metallic configuration. On the right, we show it circumscribed by the convex hull bounding our tautomeric structure superimposed over it.

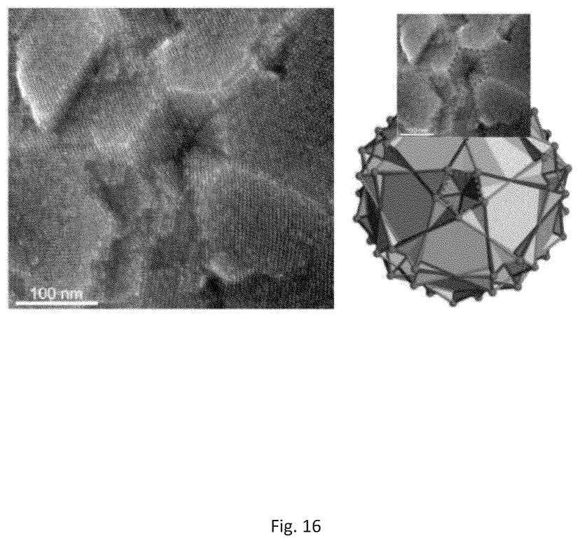

The next image in FIG. 16 on the left is from a paper by Rupich et al. Size-Dependent Multiple Twinning in Nanocrystal Superlattices [Reference 85]. Here we can see a TEM image of a large cluster of atoms. The authors experimentally verified that it has icosahedral symmetry and is composed of 20 separate sub-clusters in FCC formation. In the image to the right, we show the correlation with our 20-group by indicating the small pentagonal cone that forms at 12 locations on the surface.

The two last referenced papers are based on the multiple twinning model. This popular model is inspired by well-established experimental evidence that these clusters are composed of multiple sections of FCC arranged atoms in tetrahedral containers that self-organize into structures with icosahedral symmetry (20 tetrahedra) or pentagonal symmetry (5 tetrahedra). However, as stated above, these theoretical models cannot be that simple. They are faced with the problem of predicting cluster strain, which occurs due to the inability of the tetrahedral boundaries of the metallic sub-groups to kiss faces and be rotationally symmetric in clusters of 5 and 20 tetrahedra. Accordingly, both models conjecture distortions and dislocations in the otherwise perfect metallic FCC structure. The distortion causes energetic strain in the models, which would be inaccurate if our model without tetrahedral distortion is the correct model. Indeed, there is strong evidence these models (Mackay and multiple twinning) are incorrect, as shown by the significant mismatch between experiment and model prediction [Reference 24]. As we have shown [Reference 82], our special angle precisely forms symmetric face kissing arrangements of 5 and 20 tetrahedra.

Instead of dislocations, we employ the aforementioned rotation value to—the only possible rotation that achieves closing of the tetrahedra face gaps. In addition, it is the only rotation that reduces the number of parallel planes (faces) in the structure to the minimum possible, which is 10. It also is the only angle that leaves the angle between faces the same as they would be in an ordinary icosahedron.

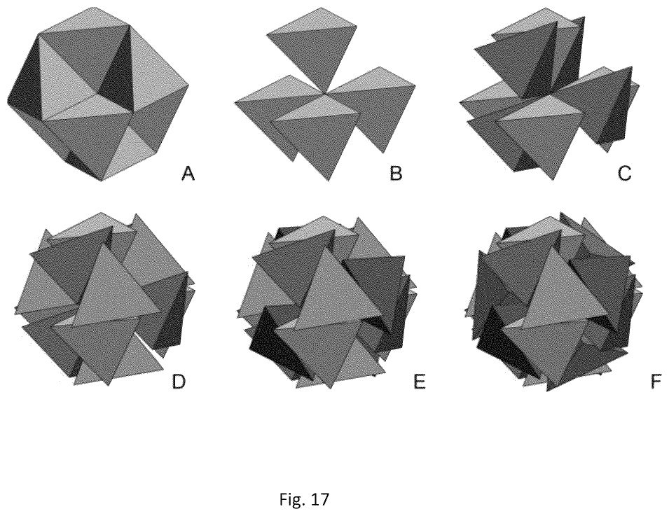

It is important to realize that there are not 20 metallic chunks in our model. There are actually only five. As shown in FIG. 14, each tetrahedron in the group of 20 is a member of a group of four tetrahedra, as shown in B in FIG. 17.

Each group of four is rotated by ArcCos[(3φ−1)/4]° from the other four groups of four tetrahedra. Metallic bonding relates in large part to the FCC lattice symmetry and inherent 60° and 90° angles of that structure. We focus on three geometric and one beat/temporal organization that drive quantum wave function correlation and, accordingly, energetics: (1) The strongest correlation is with each set of four atoms in close packed metallic configuration. (2) The second strongest is between each of the five tetrahedral groups (colors gold, red, green, dark blue and purple above), each containing a total of 4×4=16 atoms as a single 16 atom subspace of the FCC metallic lattice (e.g. image B above would contain four atoms in each of its four tetrahedra). (3) The third strongest correlation is formed by the 80-atom supercluster's icosahedral symmetry combining all five metallic 16-groups with their 20 metallic subgroups. The total quantum correlation of the five overlapping wave functions results in a low energy state for the 80-group nanocluster. (4) The dynamical energetic stability of the high-speed oscillation of the full tautomeric permutation cycle is a final contribution to the overall energetics of the supercluster. The dynamic equilibrium of such isomeric systems is often the tipping point factor that makes tautomeric systems the lowest energy clusters for a given number of atoms.

This cluster of 80 atoms has a hollow core and can also be nano-engineered with an atom at the center of either the same species of a different one. Larger and smaller clusters can be engineered under this motif which also allow for a nuclear active environment. In the technical book, Quasicrystals: Current Topics, the authors state [Reference 86]:

The nature of tunneling states is not yet elucidated, but the efficient coupling of them with phonons assumes that their dynamics are related to the structure rearrangements. The rearrangements may involve many atoms but it is common to illustrate the principle one by one atom in a double-well which can jump from one minimum to the other the resemblance of this picture to the atomic jumps in quasicrystals as well as the experiments on quasicrystal showing the low temperature anomalies typical for the amorphous solid were the origin of many attempts to identify the phasons with tunneling states.

Many chiral molecules exist in nature and a good number of them are tautomeric. For example, in Chiral Fluctuations and Structures [Reference 87] Lubensky et al. explain how a molecule can appear non-chiral if it has a 50/50 distribution of rapid right and left twist states: “ . . . left-handed twists and right-handed twists will occur with the same probability.”

In “Chiral Guest Binding as a Probe of Macrocycle Dynamics and Tautomerism in a Conjugated Tetrapyrrole, “Labuta et al. state [Reference 88]:

Both tautomerism and macrocycle inversion can be influenced in a non-trivial way depending on temperature and the respective concentrations of the tetrayprrole host, chiral guest or water. Chirality of the interacting guest is the key feature since it permits separation and detailed observation of macrocyclic inversion and tautomerism . . . . This work establishes a connection between the important chemical concepts of chirality, tautomerism and macrocyclic dynamics.

### Curvature Vs Rotation

One aspect of emergence theory relates to the notion of tension or frustration between 4D and 3D or between any higher and lower dimension. In their book Geometrical Frustration [Reference 89], Jean-François Sadoc and Rémy Mosseri develop the concept of geometric frustration to elucidate the structure and properties of non-periodic materials such as metallic glasses, quasicrystals, amorphous semiconductors and complex liquid crystals. They illustrate how it can be used to identify ordered and defective regions in materials, such as the icosahedral defect regions of crystals discussed above. The concept of geometric frustration can be understood with the following example based on our quantum gravity formalism.

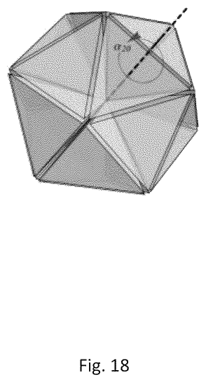

We can project to 4D a slice of the crystal made by placing unit length edges between points of the 8D E8 lattice. This particular projection is known as the Elser-Sloan quasicrystal [Reference 90]. Around each vertex, there are 20 regular 3D tetrahedra. The outer vertices of those 20 tetrahedra form the 12 vertices and 30 edges or an ordinary 3D icosahedron. An icosahedron in 3D can be thought of as being segmented by 20 tetrahedra that are distorted by a golden ratio factor. However, in 4D, all 20 tetrahedra live in different 3D subspaces. So they have “enough room” to spread out and be regular. Now, imagine we want to slowly fold this 4D space containing 20 tetrahedra down into 3D. One way to do it is by projection. If we project this 4D object to 3D, we distort each tetrahedra by a golden ratio value in order to “release” the geometric frustration or tension. We produce a regular icosahedron. This projection from 4D to 3D encodes information in the golden ratio based edge distortions of the tetrahedra edges running from the outside vertices of the icosahedron to the shared vertex at the center. That is, the projection itself is a map that encodes the information of the “mother” object in 4D. The key information about the 4D group of twenty tetrahedra is that each tetrahedron is related to the other by a face-to-face rotation of ArcCos[(3φ−1)/4]≈15.522°+60°=ArcCos (¼)°. When we project to 3D these 20 tetrahedra that live in 4D and are rotated from one another by this golden ratio based angle, we contract inner edges of the group of 20 by a factor of Sqrt[φ(Sqrt5)]. The golden ratio based edge contraction encodes, in part, the golden ratio based rotational relationship between tetrahedra in the 4D group of 20. The following geometric thought experiment may be helpful. Consider 20 regular tetrahedra in 3D space evenly arranged around a shared center vertex, as shown in FIG. 18.

Imagine curving the flat 3D space into a spherical 3D space—a 3-sphere that lives in 4D. This is analogous to the flat surface of a trampoline being curved into the third dimension by a bowling ball at the center. The curvature of the 3D space allows the 20 tetrahedra to kiss faces. So this 4D space is exactly the 3D space that is curved until it becomes a perfect 3-sphere. As we slowly curve the 3-space of the 3D group of 20 tetrahedra, the gaps slowly close. When they fully close (kiss), they are exactly the 4D group of 20 regular tetrahedra that live in the 600-cells of the Elser-Sloan quasicrystal. And each tetrahedron of a given 20 group lives in a different 3D space but still kisses faces on common planes with other tetrahedra and where all 20 share a common center vertex. The curvature value of the 3D space to complete the closure of gaps is 1/φ.

Conversely, when we instead project the 20 tetrahedra in the 4D space to 3D, the edges contract by Sqrt[φ(Sqrt5)]. But in the curvature example above, we rotated each tetrahedron into separate 3D spaces of a 4D space, just as folding a piece of paper with squares on it will rotate some squares into different 2D spaces. If we decide to rotate the tetrahedra from 4D to 3D in a different manner, where we insist that the faces kiss at each increment of a slow rotation of each tetrahedron living in 4D into a shared 3D space, there is only one way to accomplish this. We must rotate each upon an axis running from an outside face center through the shared inner vertex by Buckminster's famous “jitterbug rotation” that morphs crystal shapes like cuboctahedra to icosahedral shapes. That is the angle mentioned above, ½ [ArcCos (¼)−ArcCos (−½)].

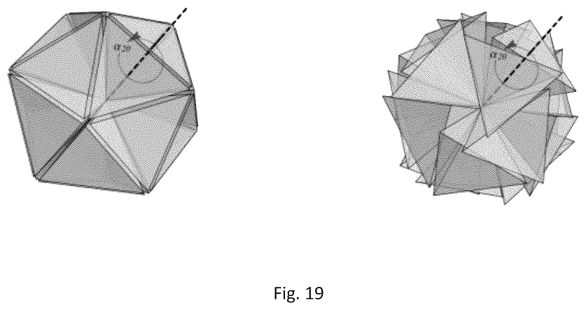

FIG. 19 illustrates the evenly spaced 20-group and the left chirality 20-group after application of the special golden ratio based rotation. Here, we show two ways to release the geometric frustration caused by the need to represent a 4D object in a lower dimensional space. In the case of projecting the 4D 20-group to 3D, the geometric frustration is expressed in the form of golden ratio based edge contractions. And in the case of the golden ratio based rotation method described, it is expressed with non-contracted edges that are rotated to release the “tension”. The rotation method encodes the 4D golden ratio information that would ordinarily be in the form of the Sqrt[φ(Sqrt5)] edge contraction in the projection method. With the rotation method, the golden ratio value of ArcCos[(3φ−1)/4]≈15.522° expresses this information. Both the golden ratio contraction value and rotation value encode the ArcCos[(3φ−1)/4]≈15.522°+60°=ArcCos (¼°) value that expresses the relationship of the 20 tetrahedra to one another in the 4D space. They are both good transdimensional mappings in this regard. However, our approach creates a few interesting things. We take 3D slices of the Elser-Sloan [Reference 90] E8 based quasicrystal and rotate them from one another by ArcCos[(3φ−1)/4 in order to encode the symmetry of the quaternionic 600-cell and the octonionic based E8 lattice, both of which are important for gauge symmetry unification physics. This provides us with a crucial binary sign value that is exploited in our model: chirality. The projective method does not create chirality. We build physics based on H3 symmetry that encodes H4 symmetry from an object in 4D that itself encodes the E8 lattice. It is perhaps most elegant to think of this 4D to 3D relationship in the form of the 20 tetrahedron group that can live in 4D or 3D. As stated, the curvature of the 3D space necessary to allow all 20 to live together in the 4D space is 1/q. And that value is inversely related, according to a parabolic partial differential function, to the rotational expression/release of geometric frustration that is ArcCos[(3φ−1)/4].

Put simply, the 15.522° rotation expresses in 3D the relationship of tetrahedra living in special symmetric relationships in 4D. Using patterns of this rotation with tetrahedra in 3D, as we do in emergence theory, is essentially painting 4D curvature in 3-space via rotation instead of actual curvature.

LENR with Clathrate Guest-Host Systems

In one embodiment, our model indicates that one approach is to use FCC based golden ratio twisted tunneling nano-clusters described above inside electromagnetic (EM) traps that suspend and segregate the clusters so they can oscillate freely.

Discrete long-range integer multiple of Planck length hops, i.e., tunneling, require degree of freedom restriction over (1) translational coordinate, (2) orientation and (3) temporal domains. Accordingly, the trapped and suspended guest cluster must be anti-paired with its host. If the host has cubic or tetrahedral symmetry, the guest must have icosahedral symmetry. And if the host has icosahedral symmetry, such as in the Tsai type quasicrystal and approximant, the guest must have cubic or tetrahedral symmetry. Again, the maximal degrees of non-zero freedom over space and time are two. The quintessential example of this in space is the 1D string of double well potentials known as the Fibonacci chain. And over the time domain, it is the anharmonic oscillator based on two frequencies related as the golden ratio.

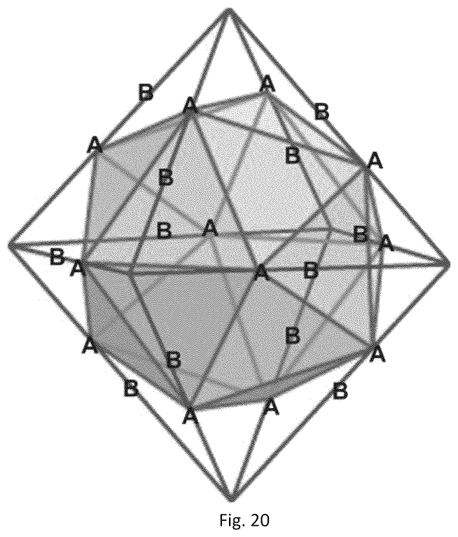

FIG. 17 illustrates an icosahedron inscribed in an octahedral cage at the “A” orientation with potential to flip to the “B” orientation. The illustration in FIG. 20 shows how there are only two orientations at the lowest energy state of an icosahedral cluster trapped in a cage with cubic symmetry. We can call these orientations A and B. They divide the edge of the cage into the golden ratio with the 0.618 . . . or 1/Φ portion on one side of the line or the other, the A or B side. It requires little energy for the cluster to oscillate between the two orientations in tautomeric tunneling fashion. Each individual atom exchanges position along a physical analogue of a Dirac delta function double well potential, between the A and B energy wells.

Similarly, our 80-group atomic cluster model with its icosahedral symmetry will have only two equally low energy states in the cubic symmetry cages of sodium zeolite y. The right and left permutations of this chiral isomer are decomposable into the tunneling oscillations of individual palladium atoms in deep narrow double well potentials.

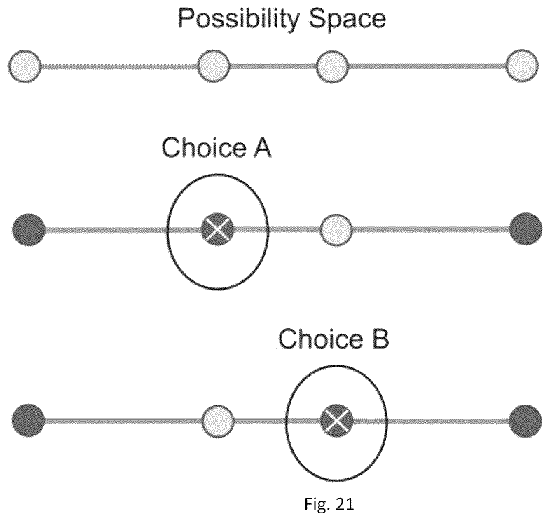

FIG. 21 illustrates a 1D energy landscape, wherein the darkly shaded circles represent atoms occupying energy wells and where the atom with the “X” has its lowest energy state at well “A” or “B” can tunnel between the two locations.

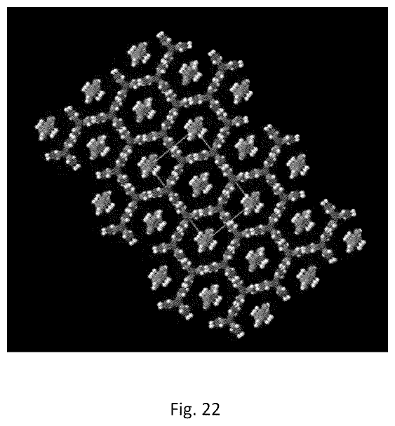

The IUPAC (International Union of Pure and Applied Chemistry) defines clathrates as inclusion compounds in which a guest molecule is trapped in a cage formed by the host molecules or a lattice of such guests and host-cages [Reference 98]. FIG. 22 is the 3:1 inclusion complex of urea and 1, 6-dichlorohexane, where guest clusters are suspended in traps at the centers of each host-cage.

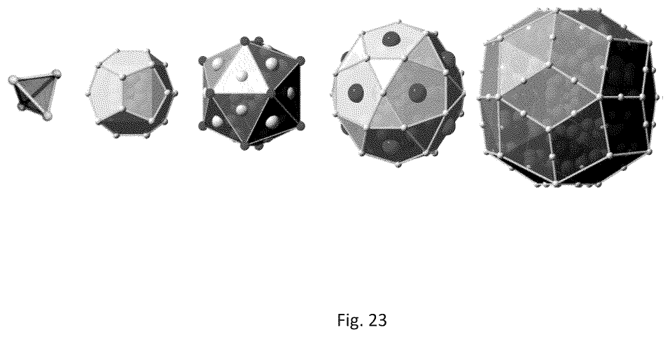

It is often the case that the guest-host symmetries include one each of (1) icosahedral symmetry and (2) cubic or tetrahedral symmetry, where the guest cluster has one symmetry and the host-cage has another. FIG. 23 illustrates Tsai type quasicrystal and approximant that consists of a five-shell structure, where the four outer shells have icosahedral symmetry and the inner cluster has tetrahedral symmetry.

FIG. 23 illustrates the example of the Tsai type quasicrystal approximant cell, wherein the first layer, acting as the dynamic guest, has tetrahedral symmetry and the cage layers that trap it have icosahedral symmetry. Quasicrystal approximants are clathrates when the unit cells contain a trapped guest cluster. The tetrahedral cluster at the center of the Tsai type quasicrystal appears to tunnel between its five energetically allowed orientations, even at temperatures below 122K [Reference 32]. In combination with its cage, it is a highly dynamic isomer with atoms changing position and bond relationships with and within the cage at sub-picosecond timescales.

As the Tsai type tetrahedron tunnels between its five equally low energy orientations, each individual atom tunnels along a 1D deep and narrow double well potential from coordinate A to B.

One of many possible guest host systems that will allow LENR is our 80-atom cluster trapped in a sodium zeolite y cage. That is, an icosahedrally symmetric guest cluster trapped in a host cage with cubic symmetry.

Guest-host systems in general are known to anharmonically oscillate [References 99-101]. In the paper, Anharmonic effects in the Fibonacci-chain quasicrystals, Zubov et al. state [Reference 102]:

Just the anharmonicity is responsible for the thermal expansion of solids, in particular, quasicrystals . . . at constant pressure, the effective amplitudes of the thermal atomic vibrations are enhanced as a consequence of the anharmonic effects.

That is, the golden ratio based dynamical oscillation of quasicrystals increases the net distance covered over a given number of particle oscillations (where “net distance” is the distance of each hop—its amplitude times the number of oscillations of the particle), as discussed above in the discussion about tunneling probability lensing.

An anharmonic oscillator that is not chaotic is a quasicrystalline beat, wherein the degrees of timing freedom are exponentially reduced as compared to the chaotic anharmonic oscillator. However, the reduction in freedom is not zero, as is the case with the harmonic oscillator—a periodic mono-beat—where the temporal degree of freedom is zero—only one option—purely periodic. A reasonable analogy is music, which cannot be defined as a single monotonous beat nor as chaotic noise. Generally, music is non-zero freedom-constrained beat oscillations over the time domain. Dubinko, Laptev and Irwin [Reference 35] show that timing of dynamic action, such as phonon and phason behavior in a quasicrystal approximant, such as our icosahedral palladium deuteride clusters trapped in zeolite cages, will “dance” in an exponentially constrained and coordinated quasiperiodic manner to (1) exponentially increase the average integer multiple of Planck lengths by which an oscillator tunnels to its next coordinate during two frames of quantum gravitational based change (change of coordinates restricted to the points of a spacetime quasi-lattice) and (2) minimize destructive interference, thereby increasing the total distance covered as the sum of discrete coordinate changes of a system of oscillators, i.e., potentiating amplitude and changing thermal behavior. The Dubinko paper does not assume a quantum gravity framework. Accordingly, it does not speak in terms of integer multiples of the Planck length but instead of classic smooth motion, where non-chaotic anharmonic beats drive exponentially increased tunneling probabilities.

In one embodiment, a method of fabrication is a variation of one developed by Timothy Boyle of Sandia and coauthors [Reference 107], to grow nano-clusters of palladium in zeolite cages. However, in our case the precise composition and time/temperature profile of the material is selected to quench in a desired nanoengineering structure for LENR.

### Geometry and Quantum Mechanics

As explained, the tunneling palladium phason flips are a prime mover in this model for LENR. However, the most frequent fusion events are between two or more deuterium atoms. Part of the reason for the long delay of the theoretical understanding of LENR is because there is no successful (predictive) quantum gravity theory of discretized space and time with particles acting as patterns according to a code on a point-like pre-spacetime substructure. That is, the conjecture of smooth spacetime and electrons and quarks as dimensionless points may be flawed. If so, it can inspire incorrect physical models for things like low energy nuclear reactions. One such misdirection is the tendency to not focus on the bipolar (being non-isotropic and having two distinct sides) nature of particles such as quarks and electrons, although such notions do exist in particle physics in the form of dipoles.

Schrodinger solved Dirac's equation for electron motion and realized they must have a rapid speed of light oscillation that he called zitterbewegung [Reference 55]. This is believed to be caused by electromagnetic zero-point energy fluctuations. Bernard Haisch said [Reference 108]: “ . . . [zitterbewegung motion] suggests a physical interpretation of the wave function and the associated probability density.”

Like Haisch's view and like David Bohm's pilot wave interpretation of quantum mechanics, emergence theory postulates a physical interpretation of the quantum wave function. Haisch continues: “ . . . simulations that have recently been done show that . . . the zitterbewegung [of the electron] acquires a helical motion suggestive of spin.”

Emergence theory views spin similarly. Electrons and quarks are based on a Planck scale 20-group of tetrahedral units of space, which take a helical motion through a quasiperiodic point space called the quasicrystalline spin network [Reference 109]. Helices have chirality with an absolute (non-relativistic) right or left handedness. It would follow then that when electrons move in an aligned train of dipole and, accordingly, spin oriented motion along some direction in an ordinary current, a chiral magnetic field will wind around them. The chirality will be exactly that of the chirality of helical paths taken by the train of electrons themselves—the current. In other words, emergence theory predicts from first principles that the magnetic field will be right handed because the helix of a propagating train of electrons is right handed. Of course, it is true that, as electrons move together in a current, a magnetic field wraps in a right handed fashion around them. There is no such thing as an electron at rest. So there is no such thing as an electron that is not moving through space with an absolute chirality. Zitterbewegung and zero-point electromagnetic radiation models, the so called “ZPF,” if true, ensure this. And the magnetic force acting on a moving charged particle is the cross product of the velocity vector and the magnetic field vector. Accordingly, when these two vectors are parallel, the magnetic force acting on them is zero. When they are perpendicular, the greatest force occurs. Of course, they are never perfectly parallel or perpendicular in nature. This fact is yet another argument that a fundamental particle must always move in a helical path. Furthermore, even if one imagined an ideal case where the two vectors were parallel or perpendicular for some moment, a moving charged particle is never free of the subtle asymmetry of the many other electric fields around it both near and far. As a result, a charge always moves through space along a helical path. Specifically, positive charged particles move in a counterclockwise direction while negative particles, like electrons, move in a clockwise or right-chirality helical pattern, creating right handed magnetic fields around them.

Anderson says [Reference 91], “The ordering of shapes appears to arise from the emergence of directional entropic forces (DEFs) that align neighboring particles.” Anderson. Anderson describes the DEFs as being “an emergent, entropic effect that arises from the geometry of the shape itself.” He describes it as a shape entropy that affect structure in which shape affects the bulk structure in view of how crowded particles optimize their local packing.

Clearly, quantum mechanics is deeply geometric because the quantum wave function for a particle fills in a probability distribution map plotted onto ordinary 3D space in the form of p-orbital geometries and other spatial patterns of probability density distribution. These 3D wave function objects are always dipolar in some way, where their geometry is elliptical or in the shape of a teardrop or a torus. Reality itself and all possible measurements we can make within it are fundamentally geometric. However, non-experimentally supported conjectures of smooth spacetime and dimensionless point particles sometimes deprive theorists of the ability to visualize geometrically. Adoption of non-geometric abstract quantities, such as “spin,” may have held back progress for some years if indeed there is a deep underlying geometric explanation for charge, spin, magnetic polarity and other abstract values. With different assumptions, we can envision physically realistic models with less abstract and enigmatic ideas such as actual chirality and discretized (step-wise) geometric rotation or spin. If such a framework became rigorous and physically realistic, the directionality and chirality of magnetic moments and other dipoles would be seen in a more precise light and the new models would be more powerful in terms of the explanation and prediction of outstanding physical anomalies as well as non-anomalous phenomena.

Emergence theory is similar to loop quantum gravity and causal dynamical triangulation insofar as starting with quantized spacetime and viewing particles as patterns within that system. And it is similar to string theory in its close association to the standard model of particle physics via the hyperdimensional geometry and associated Lie algebras upon which that most powerful gauge symmetry unification model is built. It is also similar to string theory in another way. It employs the notion of closed and open strings that are discretized into Planck length segments, and where a music-like focus on resonant interaction is paramount. Instead of generalized strings, emergence theory employs the formalism of the knot-braid theoretic aspects of Fibonacci anyons to describe string like vibratory objects in the quasicrystalline spin network.

The mathematics of this model starts with a 4D quasiperiodic point space derived via projection of a slice of the E8 lattice [Reference 110]. “The algebraic analogue of . . . simulations that have recently been done show that . . . the zitterbewegung [of the electron] acquires a helical motion suggestive of spin.”

Emergence theory views spin similarly. Electrons and quarks are based on a Planck scale 20-group of tetrahedral units of space, which take a helical motion through a quasiperiodic point space called the quasicrystalline spin network [Reference 109]. Helices have chirality with an absolute (non-relativistic) right or left handedness. It would follow then that when electrons move in an aligned train of dipole and, accordingly, spin oriented motion along some direction in an ordinary current, a chiral magnetic field will wind around them. The chirality will be exactly that of the chirality of helical paths taken by the train of electrons themselves—the current. In other words, emergence theory predicts from first principles that the magnetic field will be right handed because the helix of a propagating train of electrons is right handed. Of course, it is true that, as electrons move together in a current, a magnetic field wraps in a right handed fashion around them. There is no such thing as an electron at rest. So there is no such thing as an electron that is not moving through space with an absolute chirality. Zitterbewegung and ZPF models, if true, ensure this. And the magnetic force acting on a moving charged particle is the cross product of the velocity vector and the magnetic field vector. Accordingly, when these two vectors are parallel, the magnetic force acting on them is zero. When they are perpendicular, the greatest force occurs. Of course, they are never perfectly parallel or perpendicular in nature. This fact is yet another argument that a fundamental particle must always move in a helical path. Furthermore, even if one imagined an ideal case where the two vectors were parallel or perpendicular for some moment, a moving charged particle is never free of the subtle asymmetry of the many other electric fields around it both near and far. As a result, a charge always moves through space along a helical path. Specifically, positive charged particles move in a counterclockwise direction while negative particles, like electrons, move in a clockwise or right-chirality helical pattern, creating right handed magnetic fields around them.

As quoted above, Anders says [Reference 91], “The ordering of shapes appears to arise from the emergence of directional entropic forces (DEFs) that align neighboring particles.” These shape-influenced forces are directional, non-trivial and compete with forces such as the van der Waals force.

Clearly, quantum mechanics is deeply geometric because the quantum wave function for a particle fills in a probability distribution map plotted onto ordinary 3D space in the form of p-orbital geometries and other spatial patterns of probability density distribution. These 3D wave function objects are always dipolar in some way, where their geometry is elliptical or in the shape of a teardrop or a torus. Reality itself and all possible measurements we can make within it are fundamentally geometric. However, non-experimentally supported conjectures of smooth spacetime and dimensionless point particles sometimes deprive theorists of the ability to visualize geometrically. Adoption of non-geometric abstract quantities, such as “spin”, may have held back progress for some years if indeed there is a deep underlying geometric explanation for charge, spin, magnetic polarity and other abstract values. With different assumptions, we can envision physically realistic models with less abstract and enigmatic ideas such as actual chirality and discretized (step-wise) geometric rotation or spin. If such a framework became rigorous and physically realistic, the directionality and chirality of magnetic moments and other dipoles would be seen in a more precise light and the new models would be more powerful in terms of the explanation and prediction of outstanding physical anomalies as well as non-anomalous phenomena.

Emergence theory is similar to loop quantum gravity and causal dynamical triangulation insofar as starting with quantized spacetime and viewing particles as patterns within that system. And it is similar to string theory in its close association to the standard model of particle physics via the hyperdimensional geometry and associated Lie algebras upon which that most powerful gauge symmetry unification model is built. It is also similar to string theory in another way. It employs the notion of closed and open strings that are discretized into Planck length segments, and where a music-like focus on resonant interaction is paramount. Instead of generalized strings, emergence theory employs the formalism of the knot-braid theoretic aspects of Fibonacci anyons to describe string like vibratory objects in the quasicrystalline spin network.

The mathematics of this model starts with a 4D quasiperiodic point space derived via projection of a slice of the E8 lattice [Reference 110]. The algebraic analogue of attractive force. Empire waves are explained below, although further details about empire waves are found in the attached list of references.

We now move to a deeper discussion about quantum mechanics being more associated with geometry than is generally known and from there to a deeper consideration of our LENR theory.

In their paper, “Sub-barrier fusion and selective resonant tunneling,” Li et al. expound upon a remarkable idea [Reference 117]. In short, they show that one can use the complex number plane to explain experimental results of deuterium and tritium fusion. At some distance, 1, they plot the degree of resonance, R, between the quantum wave functions of a deuterium and tritium atom onto the real part of the complex plane. And they plot the degree of damping, D, of the two wave functions onto the imaginary part. When R=0 and D=−1, the probability for tunneling exponentially leaps from virtually impossible to 100% probable. Accordingly, nuclear fusion between deuterium and tritium occurs.

Their approach fully comports with quantum mechanics and the reported observational result matches perfectly with their quantum mechanical calculations. Now, let us probe a bit further to discuss, in a deductive manner, the meaning and implications of their work. The exponential increase in tunneling probability a result of the wave function resonance and damping values in the abstract model on the complex plane being 0 and −1. But what is the physical driver of the two values—the idea of “resonance” and “damping” of the two wave functions? After all, the wave function is considered by most to be an abstract modeling object that is not physically real. On the other hand, we must keep in mind Feynman's reminder that no one understands quantum mechanics yet. As stated, a minority of scientists contend that the quantum wave function itself is a physical object. The de Broglie-Bohm pilot [Reference 38] wave interpretation of quantum mechanics is one example. Our model, emergence theory, is another that treats the wave function as a physical object associated with an empire wave.

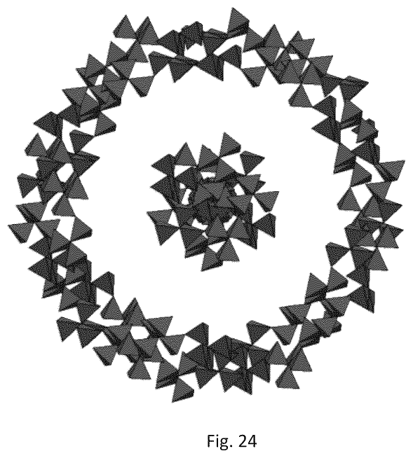

We mentioned empires previously. Particles in our quasicrystalline formalism are patterns built of vertex types in a quasicrystal. Around a typical vertex, there exists a set of other vertices that are forced to be on in that frame of trit state selections on the tetrahedral possibility space—the quasicrystalline spin network. The forced vertices are called the “empire” of the first vertex. Within the empire of each vertex, there are “rays” or beams of tetrahedra emanating from the vertex. These rays are denser than other lines that can be drawn from the center. That is, there are lines or rays of tetrahedra in the empire that are denser, such that the density of empire trits around a particle drops with distance. An empire is chiral. Dynamically, it waves and is called an empire wave. One may also average it out and think in smooth terms to call it a field or discretize it and call it a quantum field. The illustration of FIG. 24 represents a small region of the empire around a quasiparticle in our model corresponding to a 20-group particle in the center surrounded by two layers of its empire.

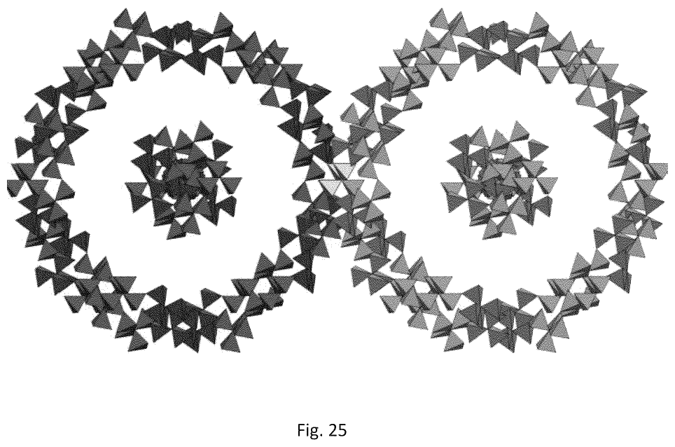

The empire wave in our model is the origin of the quantum wave function—the physical geometric first principles machinery “under the hood” of the statistical probability theory that is quantum mechanics. And relative orientation of these empire waves determines interaction probabilities, such as tunneling. For example, in the diagram of FIG. 25, when these two waves are oriented one way, the system saves frames because coincidental trits (as indicated by three lightly shaded tetrahedra in the center of the diagram) serve pattern positions for two quasiparticles, causing an attractive force. The empires of two different 20-groups have overlapping and paired needs, such that can share tetrahedra.

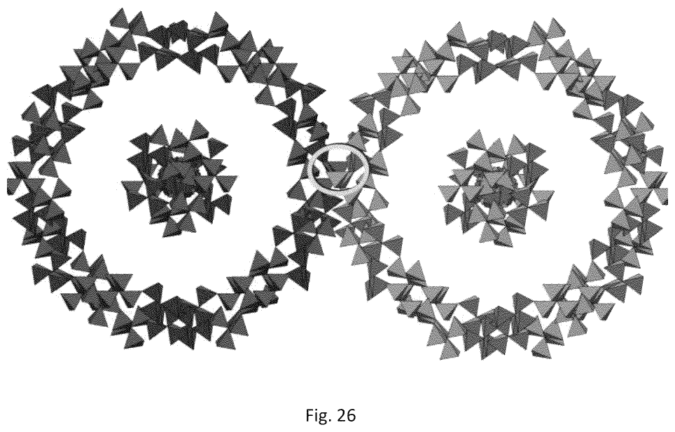

And when they do not overlap, this corresponds to the anti-paired case of FIG. 26, where the overlap is in conflict and where there the two empires do not share tetrahedra of the same chirality at the overlapping regions (as indicated by the oval). As a result, no frames are saved. A “clash” would occur so the system cannot allow both particles to propagate along their previous directions in that frame. The physical realization is a repulsive force and deflection.

Saving frames results in two things: (1) the integer multiple of Planck lengths involved in the always-discrete coordinate changes on the point space of a particle becomes large such that it would behave like a quantum leap or a tunneling phason hop, and (2) the proper orientation of the overlapping empire waves shifts the relationship from being highly repulsive at most points to a “sweet spot” of high trit parity or coincidence, where both particles' empires have a pattern of trits that are highly correlated. When trits are anti-correlated, such as one empire needing an on-right registration of a tetrahedron at coordinate X and the empire of a nearby particle needing an on-left registration of a tetrahedron at coordinate X, repulsion results because the system cannot satisfy the pattern-propagation requirements of both particles in that frame of trit state selection on the quasicrystalline spin network.

While this is a somewhat simplified model, nonetheless, we may draw out connections to the notions of bipolar orientations, such as dipole orientations, in emergence theory, as discussed in this section, and the physical meaning of the critical wave function relationship reported by Li et al. [Reference 117]. As mentioned, the quantum wave function is a three-dimensional object, as a plot of probability density for finding a particle in space. This 3D object, the probability plot, is not isotropic. It is asymmetric-specifically dipolar. This is because the orientation of the wave functions of these two atoms is defined, in part, by the relative orientations of their magnetic dipoles and electric dipoles and by the spin orientations of their atomic nuclei.

In “Stark Effects on Rigid-Rotor Wavefunctions: A Quantum Description of Dipolar Rotors Trapped in Electric Fields as Pendulum Oscillators,” Henderson and Lodsdon [Reference 118] observed that the orientation of the quantum probability plot is affected by EM fields. In other words, the free-rotor wave functions change into harmonic oscillator type wave functions. Logically, when the relative dipolar-dipolar orientation of two particles changes, the resonance and damping of their quantum wave functions also change.

Now, what is the likelihood, in vacuum space, that the relative dipole-dipole orientations between an adjacent pair of deuterium and tritium atoms will be adjusted such that R=0 and D=−1 per the Li paper? Needless to say it is very unlikely. Accordingly, fusion due to tunneling should occur only very rarely. However, one can engineer an energetic landscape that compels the two atoms to exist in any relative orientation desired. The guest-host quasiperiodic palladium deuteride structures in our LENR model strictly control the relative orientations of atoms and their nuclei. This is the case for both the palladium and deuterium atoms in the system. In fact, it is specifically their dipole orientations, along with other factors, that cause the self-organization of the structure and its stability.

Again, we refer the reader to our earlier discussion about restriction of spatiotemporal degrees of freedom correlated to “tunneling,” which we redefine as merely a very large integer multiple of Planck distances involved in the discrete coordinate change of a particle as opposed to the same distance being covered over a very large number of frames with smaller integer multiples of Planck distance changed per frame. We have explained spatial restriction as the allowed coordinate changes of the atoms. Dipole and chirality orientations (“chirality” as referred to in helical empire wave discussion) are perhaps the most subtle way to restrict freedom. The temporal factor that defines the special balance where quantum wave function resonance plots at the 0 coordinate on real line of the complex plane and damping plots at −1 on the imaginary line is the relative timing of beats as inverse harmonics composed of integer multiples of the fundamental frequency of the universe—the Planck time at 1044 frames per second.

Let us go back to the example just discussed, where, during frame-A, two propagating particles and their associated empire waves each need an on-right trit to be registered at coordinate X. What does it mean if one particle instead needs this registration during frame-B and the other during frame-A? This would mean the temporal association of the particles' wave functions is not in a resonant phase. In this case, the average integer multiple of Planck lengths of discrete coordinate change for each particle will drop significantly compared to the resonant phase, where more trits are shared resulting in more distance being expressed in the particle patterns with fewer frames being used. Accordingly, both “perfect” timing and “perfect” spatial position and dipole orientation are necessary in this new model of geometric first principles based quantum formalism.

In such a rare situation where timing, position and orientation of the particles is efficient in terms of frame (phason) conservation, tunneling probability goes from nearly impossible to highly probable and fusion results. Our model compels maximal but non-zero coordinate and orientation restriction of freedom. And it compels non-random anharmonic temporal restriction of freedom in the ways described.

The zitterbewegung [Reference 55] deductive solution implies that every particle is oscillating at a very high frequency—at light speed. It is this temporal feature of the subatomic realm that allows two or more subatomic oscillators, such as two nucleons to exist in various magnitudes of quantum wave function resonance and damping. Manipulating their spatiotemporal relationship and freedom allows for certain special magnitudes and ratios to occur, as shown by Li et al., which significantly change tunneling probability.

### More on Emergence Theory, Energy as Mass, Work, Matter and EM Radiation

Emergence theory postulates that energy is a phason flip on the quasicrystalline spin network. A phason flip can be understood as a Planck scale length. These length actions, which turn edges on or off in a graph theoretic approach to quantum gravity, express three fundamental things:

1. They can be bound in matter in the form of particle stepwise clock cycles and forward propagation along a helical path in some direction. Here, there is always a rational ratio of lengths contributing to clock cycles versus forward propagation and an inverse proportionality between propagation of the quasiparticle and its clock cycle ratio to distance covered.

2. When a unit of energy as length changes the ratio of clock time to propagation or the direction, that unit does not contribute to either. Instead, it contributes only to the change of ratio itself (and direction). This causes drag on the quasiparticle. The amount of drag or number of units of energy as lengths or phason flips is the “price” charged by the massive particle to accelerate or change direction—its mass.

3. Energy as phason flip lengths can also exist as non-massive quasiparticles that do not have a clock structure in their geometry, such as photons.

As mentioned, the model postulates a framerate of the universe of 1044 per “second,” which is the number of graph theoretic state changes on the quasicrystalline spin network over our approximate experience labeled as a “second.” So here we have a notion of a universal frame rate or an abstract notion apart from “time” that is an ordered set of graph state selections on the quasiperiodic point space. Clearly, the universe seems concerned with efficiency and the two patterns she paints with are rotation and propagation. When there is a high degree of “drag” or resistance to velocity change, there is a lot of energetic work being done over some number of frames of the 1044 per second fundamental frequency. This work comes at an expense. The local phason flips contributing to cycling and helical propagation ratio change and/or direction change are not able to contribute to clock time and propagation to the same degree.

So the system experiences drag or resistance to change. And it is specifically entropy—degree of spatiotemporal freedom—allowed by the system that defines the ratio of frames or phason flips used for clock cycles, “CC” to propagation “P” (CC+P) versus lengths as phason flips used for changing the ratio or direction, i.e., work, “W”. Nano-engineering a system using strong but non-zero restriction of particle coordinate and dipole orientation freedom expresses the maximum amount of action as clock time and propagation. In these cases, the ratio of (CC+P) to W will be high—a high degree of pattern expression for a given number of phason flips. This often takes the form of high amplitude oscillations, which can be understood as atoms discretely hopping from one energy well to another over a distance of, for example, 1025 Planck lengths.

Zero point energy, quantum vacuum fluctuation and the Dirac sea of virtual particles are synonymous terms. The deduction of this light speed high frequency fluctuation of space was realized by Max Planck in 1911 [Reference 119]. The natural consequence of this fluctuation for particles is the zitterbewegung motion. And, as stated, because all particles are in motion, all particles are moving in helical paths through space-helices that have a non-relativistic absolute chirality. In 1948, Hendrik Casimir predicted that the zero point fluctuation of virtual particles instantly appearing and disappearing in space would cause two closely spaced parallel uncharged metal plates to repel. The predicted effect has been experimentally verified.

### Casimir Forces and Yukawa Potentials

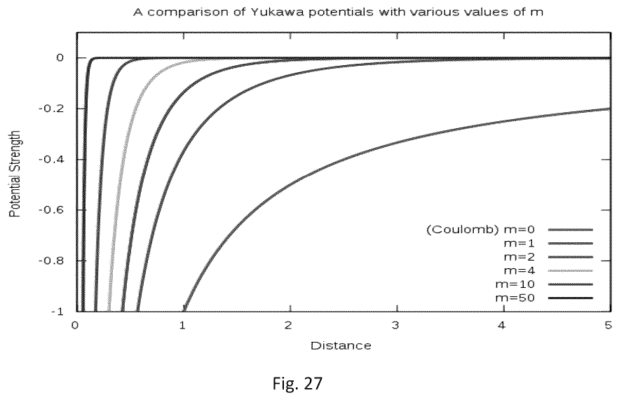

The Yukawa potential and interaction, also known as the screened Coulomb potential, relies fundamentally on particle spin alignment [Reference 120]. The potential can be used to describe the nuclear force between nucleons, as mediated by pions. It relates to the distances between nucleons, where at one distance there is repulsion and at another distance there is attraction. If the mass is zero, the Yukawa potential is exactly the Coulomb potential. FIG. 27 shows a comparison of the long range potential strength for Yukawa and Coulomb potentials. The Coulomb potential has effect over a greater distance. And the Yukawa potential approaches zero quickly.

To understand the significance of the next paragraph, recall that each tetrahedral sub-cluster in this model is a chunk of metal. And although the tetrahedral faces kiss, the atoms or spheres inscribed within each do not touch. There is a gap. This gap between two parallel metal surfaces forms a microscopic Casimir effect [Reference 54] with fluid dynamic behavior. That is, a sea of virtual particles as electron positron pairs blinking in and out of existence between the two metal surfaces acts as a super-fluidic plasma that can be modeled with the equations of magneto-hydrodynamics.

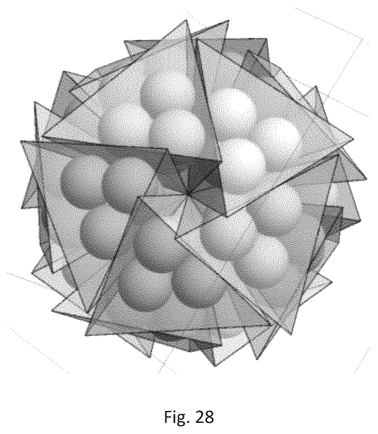

FIG. 28 illustrates an image of the 80-group of atoms, where each group of four kissing atoms are not kissing other groups of four.

In “Casimir forces in a Plasma: Possible Connections to Yukawa Potentials,” Ninham et al. [Reference 121] say:

We present theoretical and numerical results for the screened Casimir effect between perfect metal surfaces in a plasma. We show how the Casimir effect in an electron-positron plasma can provide an important contribution to nuclear interactions. Our results suggest that there is a connection between Casimir forces and nucleon forces mediated by mesons. Correct nuclear energies and meson masses appear to emerge naturally from the screened Casimir-Lifshitz effect.

And they also state:

We have explored the effect of an intervening plasma on the Casimir force between two perfectly conducting plates. The analytically derived asymptotes for large plate separations show that even spurious plasma densities can considerably reduce the expected Casimir force. In addition, the derived asymptotes show an interesting structural analogy with the Yukawa potential of nuclear interactions. We have explored this analogy to discuss whether the electromagnetic Casimir effect can possibly explain these interactions. The comparison yields predictions for the required virtual electron-positron plasma density which, however, is only achievable at very large ambient temperatures. If the potential connection to nuclear interactions is correct, then we speculate that the charged π+ and π− mesons would come out to be bound positron-plasmon and electron-plasmon excitations in the electron-positron plasma.

Via the lens of emergence theory, spin alignment in spatiotemporally restricted systems of oscillators changes the interaction of relative empire wave fields, which changes the magnitudes and attraction-repulsion phase transitions in closely arranged systems of particles. This vastly increases the integer multiple of Planck lengths in single discrete coordinate changes of the oscillators, i.e., tunneling events. The driving force of the entire system is the never-ending 1044 per second frame rate of state changes on the underlying quasicrystalline graph or point array—the quasicrystalline spin network. In this view, it is the frame rate of the universe (the ZPF) with its enormous frequency, upon which much slower oscillations of inverse harmonics as integer multiples of this fundamental frequency are built. This drives not only the exotic nano-engineered system this zeolite based icosahedral approximant clathrate object, but DNA or any other system built upon this enormously energetic background.

### Gamow Factor and the Coulomb Barrier

In the early days of LENR, there was a reaction amongst some in the scientific community that LENR was impossible. The naïve initial reaction to the idea of LENR—that it was impossible—relates to the Gamow factor model and the general enormity of the Coulomb barrier. However, things are not that simple in complex systems, such as the one described herein. Julian Schwinger said: “In the very low energy cold fusion, one deals essentially with a single state, described by a single-wave function, all parts of which are coherent. A separation into two independent, incoherent factors is not possible, and all considerations based on such a factorization are not relevant.” [References 122, 123].

Understanding LENR is not a matter of understanding how to overpower the Coulomb barrier. It is an energy minimization problem and deeply relates to the strongly correlated wave functions in special organized networks of double well potentials. The LENR model herein relies in part on a new way of looking at quantum gravity and thermodynamics.

Specifically, there is a quantity called “negentropy” introduced by Schrodinger [Reference 124]. Our physics program is based on the simple principle that spatiotemporal freedom corresponds to both entropy and negentropy. When the degrees of freedom of a system of oscillators are high, entropy or noise is high. The average integer multiple of Planck lengths in each discrete coordinate change of the particles is low. When restriction of freedom is absolute—zero freedom—as approximated in a crystal lattice, the average distance in of discrete coordinate changes (amplitude) is low, as oscillators can only discretely change coordinates around a small radius from the bottom of their energy wells. Entropy is low in this case.

However, there is a special phase. When the maximum case of non-zero restriction occurs, as can only exist when golden ratio based geometry quasicrystalline structure as involved, such as DNA or the zeolite substrate quasicrystalline approximant clathrate model presented here, negentropy is at its maximum possible level. This is not the same as “low entropy,” not exactly. This is the case of high order. An amorphous material has low order and low information in some sense but it is also complex. A crystal has high order and low information. It is not complex. A quasicrystalline arrangement of objects has high order, high information and is complex. But most important is one extraordinary aspect related to information theory. A 3D quasicrystal is a dynamic code with a finite set of geometric “letters”, syntactical rules and freedom within those rules to express various fluid dynamic patterns-phason wave dynamics.

The ultimate decomposition of this language 3D code is via seeing it as an interactive network of 1D quasicrystals. And the ultimate meaningful decomposition of these 1D quasicrystals is into a three-atom system where, a central atom tunnels back and forth over about an angstrom of distance in a deep and narrow double well potential to divide the line spanning the other two atoms by the golden ratio with the division being at one or the other of the two wells.

In fact, it is known that the golden ratio, deeply relates to (1) quantum gravity, (2) quantum mechanics, (3) atomic theory and (4) solid state materials science. Let's go over each of these factors in more detail:

1. Quantum Gravity—The golden ratio is the precise point where a black hole's modified specific heat changes from positive to negative. And it is part of the equation for the lower bound on black hole entropy. The golden ratio even relates the loop quantum gravity parameter to black hole entropy.

2. Quantum Mechanics—In 1993, Lucien Hardy, of the Perimeter Institute for Theoretical Physics, discovered that the probability of entanglement for two particles projected in tandem is—5 [Reference 125]. The results were experimentally confirmed three times in peer reviewed papers during the period 1993 to 2009. Because there is no such thing as a particle at rest, there is simpler relationship in quantum mechanics than that of two adjacent particles moving tandem along some direction.

3. Atomic Theory—Based on work done by C. H. Suresh and N. Koga in 2001, Raji Heyrovska showed the atomic radius of Hydrogen in methane to be the Bohr radius over the golden ratio, rH [Reference 126].

4. Solid State Materials Science—In 2010, a multinational team of scientists found an E8 based golden ratio signature in solid state matter. Cobalt niobate was put into a quantum-critical state and tuned to an optimal level by adjusting the magnetic fields around it [Reference 127]. The researchers used the analogy of tuning a guitar string. They found the perfect tuning when the resonance to pitch is in a golden ratio based value specifically related to the geometry of E8.

In “Overcoming the Coulomb Barrier in Cold Fusion,” the authors show how the phenomenon of LENR is best understood as an energy minimization problem, wherein Bohr radius is the key [Reference 128]. They discuss how an interactive set of quantum wave functions should be understood as a network of double well potentials: “ . . . two deuterons bound within a common volume having a multiplicity of potential wells can lead to an energy-minimized Schwinger form of wave equation with wave function overlap.”

They explain further in their article:

Energy minimization quantum mechanics can be used to model a localized charged particle pair and its response to its internal Coulomb repulsion potential. This response is normally determined by the value of Δm/am, where Δm is the DeBroglie wavelength and am is the Bohr radius of a particle of mass m. When Δm/am<<1 the energy-minimizing configuration is that of adjacent, mutually incoherent single-particle wave functions prevented from significant mutual overlap by a Gamow factor. At Δm/am>1, the particles are described by a coherent 2-body wave function in which the two particles occupy a common volume of space. The Coulomb repulsion is expressed by a correlation factor that reduces the magnitude of the 2-body wave function at the overlap “point”. An example of such a correlated 2-body wave function is the wave function of the spin-paired electrons of the helium atom. As described by Seitz, the Hylleraas second approximation wave function is s=e−αs(1+alu+b1|r12|2), where s=|r1|+|r2|, t=|r1|−|r2|, and u=|r12|=|r1−r2|, and α, a1 and b1 are the constants determined by energy minimization, and r1 and r2 are the configuration coordinate position vectors that locate the electrons relative to the helium atom center of mass. The e−αs dependence is spherically symmetric, like the charge distribution around the H atom. The second factor, involving parameters t and u, modulates the 2-electron wave function and produces a downward cusp at zero separation point where t and r12→0 can be rewritten as s(rcm,r12)=Ψ(rcm) g(rcm,r12), where Ψ(rcm)=e−2α/rcm| and g(rcm,r12)=˜1+a1|r12|+b1|r12|2. The g(rcm,r12) is a correlation function which describes the anti-correlation between electrons. The amplitude of s(rcm,r12) decreases where r12→0. I

One may conceptualize this view as either an extension of the radius of the nuclear force or as a reduction of the Coulomb barrier. But under those reasonably true notions is the more foundational idea that we propose, where golden ratio associated maximal non-zero restriction of spatiotemporal freedom of a specific form causes an extraordinary confluence of strong quantum wave correlation of various subsystems and combinations of subsystems. The lowest energy state is this organization, which forms a case of high negentropy, where the average integer multiple of Planck distances traversed by oscillators in single discrete coordinate changes is very high (“tunneling”) and where thermal noise is very low. The special state of high quantum wave function correlations is explained via quantum mechanics in the Li et al. [Reference 117] paper and correlates to dipole orientation. The emergence theory explanation also relies on dipole orientation and symmetry but goes deeper into geometric first principles by postulating the notion of empire waves made of tetrahedral trits, where oscillation frame timing and chirality matching are essential for two or more related oscillators in the quasicrystalline spin network to experience mutual attraction versus mutual repulsion.

### Quasiperiodic Lorentz-Rydeberg Gas

Not all of the deuterium loaded into this clathrate system participates in forming a quasiperiodic palladium-deuteride. A smaller fraction is in a semi-free gaseous state called a Lorentz gas [Reference 129], where its fluidic behavior is constrained not just by the boundaries but by the obstacles within the system—the atoms of the clathrate system that are anchored in deep energy wells. We refer the reader to the general theme that restriction of freedom toward the non-zero limit increases the integer multiple of Planck lengths over a discrete coordinate change of an oscillator. Because the obstacles within a zeolite cell in this quasicrystalline approximant are aperiodically ordered, we may call this an aperiodic Lorentz gas. Under the principle that the magnitude of non-zero spatiotemporal freedom contributes quantity of Planck lengths in each discrete coordinate change within a quantum gravity based non-classic system of oscillators, the aperiodic Lorentz gas of deuterium atoms is significantly restricted. For example, the relative tunneling times of multiple of palladium phasons can be highly—anharmonic but rhythmic in some sense. As a deep energy well is vacated in a tunneling event by a Pd atom, waves of coordinated Pd phason flips are occurring throughout the material. As waves of double wells are vacated, a flow pattern emerges in the deuterium Lorentz gas, all orchestrated in a highly restricted but anharmonic manner by the phasons. One simple result is that collisions are reduced—a reduction of entropic noise. The deuterium gas is allowed to directionally flow within channels in the material, reducing collisions.

In “Periodizing quasicrystals: Anomalous diffusion in quasiperiodic systems,” Kraemer et al. said [Reference 130]:

This construction [of the quasicrystalline Lorentz gas] transparently shows the existence of channels in these systems, in which particles may travel without colliding, up to a critical obstacle radius . . . we find atypical weak super-diffusion in the presence of channels, and sub-diffusion when obstacles overlap.

Emergence theory would predict that, because the integer multiple of Planck distances over discrete coordinate changes increases in a quasiperiodic Lorentz gas due to the freedom to discrete coordinate change principle explained herein, that the diffusion predictions of models that do not take this quantum effect into account will misbehave, so to speak. This would perhaps explain the anomalous diffusion result reported by Kraemer et al. in their simulation.

Free deuterium atoms in the aperiodic Lorentz gas flows reload the vacancies of the minor energy wells where deuterium are nested. Those minor energy wells are vacated by deuterium in the LENR process when they “trade up” to tunnel to the much deeper wells vacated by the phason tunneling palladium atoms to generate the primary D+D, D+D+D . . . fusion mechanism. An additional feature of a Lorentz gas of deuterium is that it can be exceptionally dense, due to the low collision rate. In this more “viscous” and orderly state, fluid dynamics plays a more profound role than in ordinary high entropy gaseous systems.

Emergence theory would model an electron in atomic orbit as a cycle of discrete coordinate changes where a vertex type in the quasicrystalline spin network is registered at a specific coordinate during a given Planck moment or frame. The full permutation cycle would occur far too fast to measure in sequential intervals, thereby making it possible to model the coordinates in an electron p-orbital cloud as being in a superposition and relating to randomness. The emergence theory picture suggests, however, there are a cycle of discrete coordinates related to regular and semi-regular polyhedra. And a Rydberg atom would be a special case, where the scale of the polyhedron around the nucleus is expanded without changing its fundamental symmetry. When Rydberg state occurs at the same energy level of the atom's ordinary state, it can be interpreted as larger integer multiples of the Plank length occurring in each discrete coordinate change of the electron through its full polyhedral permutation cycle.

We mention this briefly in order to explain an interesting path to further exploration of these ideas via Fibonacci anyons. Emergence theory has qualities very similar to Fibonacci anyons, which allow for powerful models of energetically exotic physical systems, such as Rydberg gases. Fibonacci anyons are a type of chiral knot theoretic code, wherein 1 and 1/Φ, as Direchlet integers, are the two fundamental values and where chirality is a key binary sign value in the code. Emergence theory code shares in these exact two qualities. In their paper, Interacting Fibonacci anyons in a Rydberg gas, Lesanovsky at al said [Reference 131]:

. . . we will show in detail that a Rydberg lattice gas constitutes an analog quantum simulator for Fibonacci anyons. The link between these two systems is the aforementioned exclusion principle. While for anyons this is a consequence of the underlying mathematical rules the exclusion in a Rydberg system is physically rooted in the dipole blockade which prevents the simultaneous excitation of neighboring atoms to Rydberg states. The blockade originates from large electrostatic energy shifts between atoms in Rydberg states and has recently been demonstrated experimentally for atoms trapped in individual optical traps . . . this comparatively simple quantum simulator platform for non-Abelian anyons will highlight a new route towards the study of exotic forms of quantum matter.

The work of professors Sveinn Olafsson and Lief Homlid explores the relationship of hydrogen or deuterium Rydberg gasses to the phenomenon of LENR. In introducing their slides from a talk delivered at Stanford University [Reference 132] on the scientific forum www.lenr.forum.com, the introduction to the slide presentation made public says:

These slides are from a talk delivered at Stanford, spring 2016, [and] walk through the Rydberg fusion experiments and data. This work offers both a demonstrably tested and proven theory for cold fusion as well as detailed description of the work and how it relates to other cold fusion studies. One startling discovery in this work is the emission of muons. The key condition that enables this ‘cold fusion’ to occur is the development of ultra-dense Rydberg hydrogen that forms on command within microscopic domains inside of metals. There fusion takes place but in a very unexpected neutron free form.

### Methods of Design and Fabrication

Various fabrication approaches known in the field of quasicrystals and quasicrystal approximants may be utilized to fabricate the nanoengineered quasicrystalline material.

In one embodiment, the quasicrystalline structure is a quasicrystal or quasicrystalline approximant designed to have an energy structure to favor LENR, as described previously. For example, for a quasicrystal approximant, this may include identifying host/cage quasicrystal approximant systems having a desired energy structures that favor LENR. After the quasicrystalline structure is selected, growth and fabrication of the desired quasicrystal structure is then performed using quasicrystal fabrication techniques, such as selecting the composition of major materials and dopants and selecting a time/temperature cycling to “quench” in a quasicrystal phase of matter having the desired energy structure. This may include empirically testing different time/temperature cycles and empirically varying other fabrication parameters to achieve the desired quasicrystalline materials structure.

Alternately, the quasicrystalline structure may be empirically determined by selecting a set of candidates quasicrystalline materials having general characteristics consistent with LENR and performing empirical optimization. For example, consider the case of LENR based on palladium. In this example, a set of candidate quasicrystalline materials containing palladium may be selected. Each candidate quasicrystalline material may, in turn be fabricated over a range of fabrication conditions and then tested.

In one embodiment, the fabrication of nano-engineered material may include selecting the material composition and time/temperature quenching cycle to permit large cell cages to grow, and segregate and trap dynamic tautomeric tunneling clusters of palladium atoms in a quasicrystal or quasicrystalline approximant.

As previously discussed, the design of the quasicrystal or quasicrystalline approximant may take into consideration one or more of the principles described above.

As a short summary a model for the mechanism of LENR in the nanonengineered materials may include factors such as the following:

1. The cold fusion literature contains hundreds of reports of post-experiment transmutation products indicating fusion is occurring in the same experiment from gaseous atom reactions (e.g. deuterium fusing with deuterium) and fusion between gaseous and metallic atom atoms (e.g., deuterium and palladium). Neither of these reactions seem to generate the radiation that would be expected from ordinary hot fusion. Accordingly, the heavy plus light atom fusion cannot be explained as a high energy reaction that occurs from the fusion energy generated by the light plus light atom reactions. Our model proposes how both reactions relate to one another and how both are low energy reactions enabled via quantum tunneling.

2. In some embodiments, we close the gaps in packings of five and 20 tetrahedra. This special rotation angle explains the appearance of five and 20 FCC sub-clusters in the organization of pentagonally and icosahedrally symmetric superclusters without the energetically costly distortion necessary in other models such as the Mackay icosahedron model and the multiple twinning models.

3. When this cluster is placed in a magnetic trap, it can oscillate via tunneling at low energy in tautomeric high speed fashion. Tunneling tautomeric particles trapped in cages form clathrate guest-host systems. The source of oscillation energy is the ZPF.

4. Atomic tunneling is known to occur in systems with massively restricted but non-zero degrees of freedom. In some embodiments, we intentionally exploit this effect. The most extreme example of this notion of “probability lensing” is a physical approximation of the ideal Dirac delta function double well potential known as a 1D quasicrystal phason. And over the time domain, a highly restricted non-zero level of freedom leading to high tunneling probability, i.e., high amplitude, is the quasiperiodic anharmonic oscillator.

5. As shown by Li et al., tunneling probability leading to cold fusion is known to exponentially increase between atoms when their quantum wave functions are related by special magnitudes and ratios of resonance and damping. In some embodiments, we manipulate the resonance and damping of the quantum wave functions of two particles is to adjust their relative dipolar orientations. This is achieved by the engineering of the energetic landscape of traps and double wells around the two oscillators.

7. Due to implications of quantum mechanics and the lack of evidence for smooth space and time, it may be more logical and conservative to presume spacetime has a discretized substructure. Emergence theory considers spacetime to be a dynamical quasicrystalline code. Both quantum mechanics and emergence theory lead to the simple underlying idea that the magnitude of non-zero spatiotemporal restriction of freedom is proportional to the integer multiple of Planck lengths over which an oscillator will tunnel in a given moment.

In some embodiments, we combined these ideas into our model, wherein clusters of FCC metallic lattice elements, such as Pd, are organized as 20 tetrahedral packings to form an icosahedrally symmetric supercluster. This cluster is trapped in a crystal cell (such as Na-zeolite Y) to form a tunneling tautomeric clathrate system. The addition of deuterium causes Pd+D fusion as the Pd atoms tunnel between the two coordinates of their deep narrow double well potentials. A secondary D+D, D+D+D . . . class of reactions occurs with even higher frequency, as the D atoms tunnel to the energy wells vacated by the tunneling Pd atoms. The overall system is defined by and self-organizes as a result of specific dipolar orientations of the constituent particles. We propose these orientations, obviously very different than orientations in an ordinary crystal or an amorphous structure, allow for special magnitudes and ratios of quantum wave function resonance and tunneling that potentiate tunneling, such as the values reported in the Li et al. paper [Reference 117]. The density of energy output in this precise nano-engineered structure is greater than in typical cold fusion inventions, which rely on unpredictable and sparsely distributed icosahedral micro-defects in an otherwise perfect metal or generally amorphous material.

These are examples. More generally, any of the considerations described above may be included in the design model. The design model may also be aided by computer simulations and computer analysis.

As a practical matter, the design model demonstrates attributes for designing nanoengineered materials for LENR having characteristics in which there are active sites for LENR “designed into” the nanoengineered material. This means that such active sites will tend to be distributed throughout the material and such active sites will have high tunneling probabilities for atoms (e.g., Pd or D) to have fusion reactions.

### Power Generation Apparatus, System and Methods

In one embodiment, the nanoengineered material is used in a power generating cell. This may include, for example, a chamber to permit pressurized deuterium gas to be loaded into the nanoengineered quasicrystal or quasicrystalline approximant material. A component to extract heat may be included, such as a heat extractor. A practical power generating system may also include other monitoring and control systems to monitor power output, monitor aspects of LENR, etc.

In one embodiment, the fabricated nanoengineered material is formed into a power generating cell that is placed into a chamber. The chamber permits a pressured light atomic gas (e.g., a hydrogen gas, which may be a hydrogen isotope gas such as deuterium) to enter the chamber and load the nanoengineered material. A heat exchanger or heat extractor may be provided to extract generated heat from an exothermic LENR. The pressure of the light atomic gas may be selected as an operating parameter to favor LENR.

### Hydrogen/Deuterium Storage Applications

In addition to LENR applications, the nanoengineered materials are also useful for storing hydrogen and hydrogen isotopes, such as deuterium. Consequently, in some embodiments, the nanoengineered materials have additional uses and applications as a hydrogen or hydrogen isotope storage medium.

### ALTERNATE EMBODIMENTS

Selected examples of quasicrystal structure and clathrate structure have been described. However, it is conceivable that additional, as yet undiscovered or unrecognized quasicrystal or clathrate structures may be designed in the future based on the design principles described above that perform substantial the same of one or more of the functions described above. It will be understood that modifications, variations, and equivalents to the structures and methods described above are also contemplated to be within the subject matter of this application.

It is also contemplated that further extensions are within the scope of the application. That includes methods for fabrication of the nanoengineered materials, a product fabricated by fabrication process (e.g., the nanoengineered material), and the use of the nanoengineered material to generate heat or otherwise generate power, including methods and systems for generating electric power using the nanoengineered material. Moreover, it will be understood that methods and systems for generating heat for commercial or industrial uses using the nanoengineered material are also contemplated.

While examples have been described with palladium as the heavy atom, it will be understood that other heavy atoms capable of LENR might also be candidates, based on efficiency, cost of materials, or other considerations.

### REFERENCES

The following references are each hereby incorporated by reference:
[1] A. Takibayev, M. Saito, V. Artisyuk, and H. Sagara, Fusion-driven transmutation of selected long-lived fission products, Progress in nuclear energy 47 (1-4) (2005) 354-360.
[2] W. A. Fowler, M. Burbidge, G. Burbidge, and F. Hoyle, Synthesis of the Elements in Stars, Rev. Mod. Phys 29 (4) (1957) 547-650.
[3] L. Badash, Radium, Radioactivity and the Popularity of Scientific Discovery, Proceedings of the American Philosophical Society 122 (1978) 145-54.
[4] D. Drubach, The Brain Explained. New Jersey: Prentice-Hall (2000).
[5] See, for example the articles published by the Quantum Gravity Research Organization providing an overview of the history of cold fusion research http://www.quantumgravityresearch.org/cold-fusion-overview/
[6] P. H. Diamandis and S. Kotler. Abundance: The future is better than you think. Free Press, Tantor media, ISBN9788120343047 (2012).
[7] M. Fleischmann and S. Pons, Electrochemically induced nuclear fusion of deuterium, J. Electroanalytic. Chem. 261 (2) (1989) 301-308.
[8] K. L. Shanahan, A new look at low-energy nuclear reaction research, J. Environ. Monit. Advance Article DOI: 10.1039/C001299H (2010).
[9] K. L. Shanahan, A systematic error in mass flow calorimetry demonstrated, Thermochimica Acta 382 (2) (2002) 95-100.
[10] D. L. Knies, K. S. Grabowski, D. A. Kidwell, V. K. Nguyen, and M. E. Melich, Differential Thermal Analysis calorimeter at the Naval research Laboratory, Materials Science & Technology Division, Naval Research Laboratory, Washington D.C.
[11] P. L. Hagelstein, M. C. H. Mckubre, and F. L. Tanzella, Electrochemical model of the Fleischmann-Ponn experiment, Research Laboratory of Electronics, MIT, Cambridge, MA.
[12] I. Savvatimova and D. V. Gavritenkov, Results of analysis of Ti foil afterglow discharge with deuterium, 11th International Conference on Cold Fusion, Marseilles, France: World Scientific Co. (2004) p. 438.
[13] T. Mizuno et al. Generation of heat and products during plasma electrolysis in 11th International Conference on Cold Fusion, Marseilles, France: World Scientific Co. (2004) p. 161.
[14] G. Lochak and L. Urutskoev, Low-energy nuclear reactions and the leptonic monopole in 11th International Conference on Cold Fusion, Marseilles, France: World Scientific Co. (2004) p. 421.
[15] Y. Iwamura, T. Itoh, and M. Sakano, Nuclide Transmutation Device and Nuclide Transmutation Method, Mitsubishi Heavy Industries, Ltd.: U.S.A., EP1202290 (B1) (2013).
[16] “U.S. Schools With Friendly Faculty” published online January 2013 by Cold Fusion Now: http://coldfusionnow.org/u-s-schools-with-friendly-faculty/
[17] “Cold Fusion-Hoax, Dream and Future Green Energy?” Corvallis Advocate, December 2012: https://www.pdx.edu/news/corvallis-advocate-cold-fusion-hoax-dream-and-future-green-energy
[18] “Japanese Cold Fusion LENR R&D Facility Announced,” Atom Ecology, 2015: http://atom-ecology.russgeorge.net/2015/03/30/japanese-cold-fusion-lenr-rd-facility/
[19] M. A. Johnson, Following the Footsteps of the Wright Brothers: Their Sites and Stories Symposium Papers, Wright State University (2001).
[20] B. Berger, NASA Helping U.S. Air Force Gear Up for 2009 X-51 Flights, Space.com (2008).
[21] Y. Iwamura, M. Sakano, and T. Itoh, Elemental analysis of Pd complexes: effects of D2 gas permeation, Jpn. J. Appl. Phys. A 41 (7) (2002) 4642-7.
[22] Y. Arata, and C. Zhang, Formation of condensed metallic deuterium lattice and nuclear fusion, Proc. Japan Acad 78 (2002), 57-62.
[23] R. Feynman, The Character of Physical Law, The M.I.T Press (1965).
[24] O. Kostko, B. Huber, M. Moseler, and B. von Issendorff, Structure determination of medium-sized sodium clusters, Phys. Rev. Lett 98 (4) (2007) 043401-4.
[25] J. Baggott, Quantum Story: A history in 40 moments, Oxford University Press (2011).
[26] J. Ambjørn, J. Jurkiewicz, and Renate Loll, The Self-Organizing Quantum Universe, Scientific American (2008).
[27] C. Rovelli, Loop Quantum Gravity, Living Reviews in Relativity 1 (1998) 1.
[28] G. R. Osche, Electron channeling and de Broglie's internal clock, Annales de la Fondation Louis de Broglie, 36 (2011) 61-71.
[29] P. Dirac, The Principles of Quantum Mechanics (4th ed.), Oxford at the Clarendon Press, ISBN 978-0-19-852011-5 (1958) 58.
[30] M. Razavy, Quantum Theory of Tunneling, World Scientific, ISBN 9812564888 (2003) pp. 4, 462.
[31] P. C. W. Davies, Quantum tunneling time. Am. J. Phys 73 (2005) 23.
[32] T. Watanuki, A. Machida, T. Ikeda, K. Aoki, H. Kaneko, T. Shobu, T. J. Sato, and A. P. Tsai, Pressure-Induced Phase Transitions in the Cd—Yb Periodic Approximant to a Quasicrystal, Phys. Rev. Lett 96 (2006) 105702-4.
[33] V. I. Dubinko, Quantum Tunneling in Breather ‘Nano-colliders’, J. Cond. Mat. Nucl. Sci 19 (2016) 1-12.
[34] V. I. Dubinko, D. V. Laptev, Chemical and nuclear catalysis driven by localized anharmonic vibrations, Letters on Materials 6 (2016) 16-21.
[35] V. I. Dubinko, D. Laptev, and K. Irwin, Catalytic mechanism of LENR in quasicrystals based on localized anharmonic vibrations and phasons, to be submitted ICCF20, Sendai, Japan (2016).
[36] D. Lenz, N. Strungaru, Pure point spectrum for measure dynamical systems on locally compact Abelian groups, Journal de Mathématiques Pures et Appliquées 92 (4) (2009) 323-341.
[37] N. Born, The quantum postulate and the recent development of atomic theory, Nature 121 (1928) 580-590.
[38] L. de Broglie, La mécanique ondulatoire et la structure atomique de la matière et du rayonnement, Journal de Physique et le Radium 8 (5) (1927) 225-241.
[39] D. Bohm, A Suggested Interpretation of the Quantum Theory in Terms of “Hidden” Variables, Phys. Rev. 85 (1952) 166.
[40] K. Anna, C. Cederstav, and B. M. Novak, Investigations into the Chemistry of Thermodynamically Unstable Species. The Direct Polymerization of Vinyl Alcohol, the Enolic Tautomer of Acetaldehyde, JACS 116 (1994) 4073-74.
[41] E. Schrödinger, What is life?: the physical aspect of the living cell; with, mind and matter and autobiographical sketche,. A Canto Book Series. Cambridge, UK: Cambridge University Press (1992).
[42] J. D. Watson and F. H. Crick, A Structure for Deoxyribose Nucleic Acid, Nature 171 (1953) 737-738.
[43] See the Reports available from the Drexel University Physics Department: http://www.physics.drexel.edu/˜bob/Term_Reports/Megan_Wolfe.pdf; See also the 2013 article “Quantum Tunneling in DNA” by Wolfe, Megan and Drexel University available online from Semantic Scholar
[44] O. O. Brovarets, D. M. Hovorun, Tautomeric transition between wobble A·C DNA base mispair and Watson-Crick-like A·C* mismatch: microstructural mechanism and biological significance, Phys Chem Chem Phys. 17 (23) (2015) 15103-10.
[45] C. F. Matta, Quantum Biochemistry: Electronic Structure and Biological Activity. Weinheim: Wiley-VCH. ISBN 978-3-527-62922-0 (2014).
[46] J. Anson, One for all and all for one: shape-shifting organic molecules that spontaneously resolve, Organic & Biomolecular Chemistry Blog (2012).
[47] Z. Slanina, Chemical Isomerism and Its Contemporary Theoretical Description, Advances in Quantum Chemistry 13 (1981) 89-153.
[48] A. A. Vigasi and Z. Slanina. Molecular Complexes in Earth's, Planetary, Cometary, and Interstellar Atmospheres, ISBN 978-9-810-23211-5 (1998).
[49] W. von E. Doering, W. R. Roth, A Rapidly Reversible Degenerate Cope Rearrangement: Bicyclo[5.1.0] octa-2,5-diene, Tetrahedron 19 (5) (1963) 715-737.
[50] X. Zhang, D. A. Hrovat, and W. T. Broden, Calculations Predict That Carbon Tunneling Allows the Degenerate Cope Rearrangement of Semibullvalene to Occur Rapidly at Cryogenic Temperatures, Org. Lett 12 (12) (2010) 2798-2801.
[51] W. Gerlach, O. Stern, Der experimentelle Nachweis der Richtungsquantelung im Magnetfeld, Zeitschrift für Physik 9 (1992) 349-352.
[52] “What is the fastest event,” by Scott O'Brien and Tom Diddams, published in 2004 in Scientific American: http://www.scientificamerican.com/article/what-is-the-fastest-event/
[53] H. Kragh, Preludes to dark energy: zero-point energy and vacuum speculations, Archive for History of Exact Sciences Springer-Verlag 66 (3) (2012) 199-240.
[54] H. Nikolic, Proof that Casimir force does not originate from vacuum energy, Phys. Lett B 761 (2016) 197.
[55] D. Hestenes, The zitterbewegung interpretation of quantum mechanics, Found f Phys 20 (1990) 10.
[56] A. I. Koleshnikov et al. Quantum Tunneling of water in Beryl: A new state of the water molecule, Phys. Rev. Lett 116 (2016) 1678021-6.
[57] J. Dolinsek, B. Ambrosini, P. Vonlanthen, J. L. Gavilano, M. A. Chernikov, and H. R. Ott, Atomic Motion in Quasicrystalline A170Re8.6Pd21.4: A Two-Dimensional Exchange NMR Study, Phys. Rev. Lett 81 (1998) 3671-3674.
[58] W. M. Itano, J. C. Bergquist, D. J. Wineland, Early observations of macroscopic quantum jumps in single atoms, Int. J Mass. Spec 377 (2015) 403.
[59] “Tunneling States and Defect In Quasicrystals,” by Bert et al, published 2001, www.dartmouth.edu/˜phonon/abstracts/Po-II-1-Bert.pdf
[60] A. Chakrabarti and S. Chattopadhyay, A Fibonacci atomic chain with side coupled quantum dots: crossover from a singular continuous to a continuous spectrum and related issues, arxiv.org/pdf/1112.0871v1.pdf.
[61] N. O. Birge, B. Golding, W. H. Haemmerle, H. S. Chen, and J. M. Parsey. Tunneling systems and disorder in quasicrystals, Phys. Rev. B 36 (1987) 7685-7688.
[62] N. Vernier, G. Bellessa, B. Perrin, A. Zarembowitch, and M. de Boissieu, Tunnelling States in Quasi-Crystals, Europhys. Lett 22 (1993) 187.
[63] F. Bert, G. Bellessa, A. Quivy, and Y. Calvayrac, Tunneling states in a single-grain Al—Cu—Fe quasicrystals, Phys. Rev. B 61 (2000) 32-35.
[64] K. Wang, P. Garoche, and L. Dumoulin. Focused ion beam imaging of grains in Al—Li—Cu quasicrystals, J. Phys. Cond. Matter 10, (1998), 3479.
[65] R. P. Hermann, V. Keppens, P. Bonville, G. S. Nolas, F. Grandjean, G. J. Long, H. M. Christen, B. C. Chakoumakos, B. C. Sales, and D. Mandrus, Direct Experimental Evidence for Atomic Tunneling of Europium in Crystalline Eu8Ga16Ge30, Phys. Rev. Lett. 97 (2006) 017401-6.
[66] A. Smerzi, S. Fantoni, S. Giovanazzi, and S. R. Shenoy, Quantum Coherent Atomic Tunneling between Two Trapped Bose-Einstein Condensates, Phys. Rev. Lett 79 (1997) 4950-4953.
[67] J. Gribbin, Q is for Quantum: An Encyclopedia of Particle Physics, Touchstone Books: ISBN 0-684-86315-4 (1998).
[68] C. J. Van Oss, D. R. Absolom, and A. W. Neumann, Applications of net repulsive van der Waals forces between different particles, macro-molecules, or biological cells in liquids, Colloids and Surfaces 1 (1) (1980) 45-56.
[69] R. Jackson, John Tyndall and the Early History of Diamagnetism, Annals of Science 4 (2014).
[70] W. G. Unruh, Notes on black-hole evaporation, Phys. Rev D 14 (4) (1976) 870.
[71] D. J. Griffiths, Introduction to Quantum Mechanics (2nd ed.), Prentice Hall. ISBN 0-13-805326-X (2004).
[72] J. Olsen, and K. McDonald, Classical Lifetime of a Bohr Atom, Joseph Henry Laboratories, Princeton University (2005).
[73] L. de Broglie, The Reinterpretation of Wave Mechanics, Foundations of Physics, 1 (1) (1970).
[74] I. Newton, Principia: the mathematical principles of natural philosophy (1846) p. 72.
[75] R. Sorabji, Matter, space and motion: theories in antiquity and their sequel (1st ed.). Ithaca, N.Y.: Cornell University Press. ISBN 978-0801421945 (1998) 227-228.
[76] M. P. Haugen, C. Lämmerzahl, Principles of Equivalence: Their Role in Gravitation Physics and Experiments that Test Them, ISBN 978-3-540-41236-6 (2001).
[77] A. Aspect et al., Experimental Tests of Realistic Local Theories via Bell's Theorem, Phys. Rev. Lett. 47 (1981) 460-463.
[78] G. Cavalleri, F. Barbero, G. Bertazzi, E. Cesaroni, E. Tonni, L. Bosi, G. Spavieri, and G. Gillies, A quantitative assessment of stochastic electrodynamics with spin (SEDS): Physical principles and novel applications, Frontiers of Physics in China 5 (1) (2010) 107-122.
[79] K. H. Kuo, Mackay, Anti-Mackay, Double-Mackay, Pseudo-Mackay and Related Icosahedral Shell Clusters, Structural Chemistry 13 (2002) 221-230.
[80] See Jonathan Doye's “Cluster Structure” Publication: http://doye.chem.ox.ac.uk/research/cluster_structure.html
[81] F. Baletto and R. Ferrando, Structural properties of nanoclusters: Energetic, thermodynamic, and kinetic effects, Rev. Modern. Phys. 77 (2005) 371-423.
[82] F. Fang, J. Kovacks, G. Sadler, and K. Irwin, An icosahedral quasicrystal as a packing of regular tetrahedral, Acta. Physica. Polonica A 126 (2014) 458-460.
[83] R. Boese, M. Yu. Antipin, D. Blaser, and K. A. Lyssenko, Molecular Crystal Structure of Acetylacetone at 210 and 110 K: Is the Crystal Disorder Static or Dynamic? J. Phys. Chem. B 102 (1998) 8654-8660.
[84] H. Hofmeister, Fivefold Twinned Nanoparticles, Encyclopedia of Nanoscience and Nanotechnology 3 (2004) 431-452.
[85] S. M. Rupich, E. V. Shevchenko, M. I. Bodnarchuk, B. Lee, and D. V. Talapin, Size-Dependent Multiple Twinning in Nanocrystal Superlattices, J. Am. Chem. Soc 132 (2010) 289-296.
[86] E. Belin-Ferre, C. Berger, and M. Quiquandon, Quasicrystals Current Topics, World Scientific Publishing Company, ISBN 978-9810242817 (2000).
[87] T. C. Lubensky, R. D. Kamien, and H. Stark, Chiral Fluctuations and Structures, Mol. Cryst. Liq. Cryst 288 (1996) 15.
[88] J. Labuta, Z. Futera, S. Isihara, H. Kourilova, Y. Tateyama, K. Ariga, and J. P. Hill, Chiral guest binding as a probe of macrocycle dynamics and tautomerism in a conjugated tetrapyrrole, J. Am. Chem. Soc 136 (2014) 2112-2118.
[89] J. F. Sadok, and R. Mosseri, Geometrical Frustrations. Cambridge University Press. ISBN 978-0-521-44198-8 (2006).
[90] M. Baake and F. Gahler, Symmetry Structure of the Elser Sloane Quasicrystal, arXiv:cond-mat/9809100 v1 (1998).
[91] G. van Anders, D. Klotsa, N. K. Ahmed, M. Engel, and S. C. Glotzer, Understanding shape entropy through local dense packing, PNAS 111 (45) (2014), E4812-21.
[92] H. Fu, J. Liao, J. Yang, L. Wang, Z. Song, X. Huang, C. Yang, W. Xue, F. Liu, F. Qiao, W. Zhao, X. Yin, C. Hou, C. Zhang, W. Ge, J. Zhang, Y. Wang, C. Zhou, & G. Yang, The Sunway Taihu Light supercomputer: system and applications, Sci China Inf Sci 59 (2016) 072001-15.
[93] D. Brock, Understanding Moore's Law: Four Decades of Innovation, Chemical Heritage Foundation, ISBN 0-941901-41-6 (2006) 67-84.
[94] V. L. Golo, and Yu. S. Volkov. Tunneling of protons and tautomeric transitions in base pairs of DNA, Int. J. Mod. Phys. C 14 (2003) 133.
[95] C. Drecshel-Grau and D. Marx, Quantum simulation of collective proton tunneling in hexagonal ice crystals, Phys. Rev. Lett 112 (2014) 148302-5.
[96] Z. Slanina, An interplay between the phenomenon of chemical isomerism and symmetry requirements: A perennial source of stimuli for molecular-structure concepts, as well as for algebraic and computational chemistry, Comps. & Maths. Appls 12 (3-4) (1986) 585-616.
[97] “Dr. Edmund Storms, Cold Fusion, Nuclear Active Environments and Nuclear Transformation,” published by Q-NIVERSE (2013): https://jmag0904.wordpress.com/2013/08/21/dr-edmund-storms-cold-fusion-nuclear-active-environments-and-new-energy/.
[98] G. P. Moss, P. A. S. Smith, and D. Tavernier, Glossary of class names of organic compounds and reactivity intermediates based on structure, Pure and Applied Chemistry 67 (8-9) (1995) 1307-1375.
[99] T. Takabatake, Nano-Cage Structured Materials: Clathrates. Thermoelectric Nanomaterials (2013) 33-48.
[100] Tse, J. et al, Anharmonic motions of Kr in the clathrate hydrate, Nat. Mater 4 (2005) 917-921.
[101] H. Schober, H. Itoh, A.Klapproth, V. Chihaia, and W. Kuhs, Guest-host coupling and anharmonicity in clathrate hydrates, Eur. Phys. J 12 (2003) 41-49.
[102] V. I. Zubov, N. T. Rabelo, Anharmonic effects in the Fibonacci-chain quasicrystals, Phys. Rev-B 49 (1994) 8671-8.
[103] E. Storms, Anomalous Heat Produced by Electrolysis of Palladium using a Heavy-Water Electrolyte, http://www.lenr-canr.org/acrobat/StormsEanomalousha.pdf (2006) 1-17.
[104] I. Parchamazad “Iraj Parchamazad on LENR with Zeolites” video published by Cold Fusion Now, (2012) https://www.youtube.com/watch?v=2L-IKozWjSA
[105] I. Parchamazad, M. Miles, Optimization of zeolites in cold-fusion systems, ICCF19 (2015).
[106] F. D. Smith, Deuterium in 147-atom Pd nanoclusters embedded in zeolite cages, http://vixra.org/abs/1603.0098 (2016).
[107] P. D. Burton, T. J. Boyle, and A. K. Datye, Facile, surfactant-free synthesis of Pd nanoparticles for heterogeneous catalysts, J. Catal 208 (2011) 145-149.
[108] See the Zero Point Energy articles published by Calphysics Institute: http://www.calphysics.org/zpe.html
[109] F. Fang, & K. Irwin, An Icosahedral quasicrystal & E8 derived quasicrystals, http://arxiv.org/pdf/1511.07786.pdf.
[110] T. Gosset, On the regular and semi-regular figures in space of n dimensions, Messenger of Mathematics 29 (1900) 43-48.
[111] E. Noether, Invariante Variations probleme, Nachr. D. König. Gesellsch. D. Wiss. Zu Göttingen, Math-phys. Klasse (1918) 235-257.
[112] K. Becker, M. Becker, and J. H. Schwarz, String Theory and M-Theory, Cambridge University press. ISBN: 9780521860697 (2006) 253.
[113] A. Cayley, On Jacobi's elliptic functions, in reply to the Rev.and on quaternions, Philos. Mag 26 (1845) 208-211.
[114] See the 2014 Scientific American Article by Max Tegmark, “Is the Universe Made of Math?”: http://www.scientificamerican.com/article/is-the-universe-made-of-math-excerpt/K.
[115] Irwin, Toward the unification of physics and number theory, http://arxiv.org/pdf/
[116] E. Wigner, Characteristic vectors of bordered matrices with infinite dimensions, Annals of Mathematics 62 (3) (1955) 548-564.
[117] X. Z. Li, J. Tian, M. Y. Mei, and C. X. Li, Sub-barrier fusion and selective resonant tunneling, Phys. Rev C 61 (2000) 0246101-6.
[118] G. Henderson and B. Logsdon, Stark Effects on Rigid-Rotor Wavefunctions A Quantum Description of Dipolar Rotors Trapped in Electric Fields as Pendulum Osciilators, J. Chem Ed 72 (11) (1995) 1021-4.
[119] H. Kragh, Preludes to dark energy: zero-point energy and vacuum speculations, Arch. Hist. Exact Sci 66 (3) (2012) 199-240.
[120] R. V. Reid Jr, Local Phenomenological Nucleon-Nucleon Potentials, Annals of Physics 50 (1968) 411-468.
[121] B. W. Ninham, M. Bostrom, C. Persson, I. Brevik, S. Y. Buhmann and B. E. Sernelius, Casimir forces in a plasma: possible connections to Yukawa potentials, Eur. Phys. J. D 68 (2014) 328-36.
[122] J. S. Schwinger, Quote from lecture at U. Gourgogne, In Climbing the Mountain (1990).
[123] J. Mehra, and K. A. Milton, The Scientific Biography of Julian Schwinger, Oxford University Press, New York (2000) 554-562.
[124] L. Brillouin, Negentropy Principle of Information, J. Appl. Phys 24 (9) (1953) 1152-1163.
[125] See the articles by Lucien Hardy published by Perimeter Institute of Theoretical Physics: https://www.perimeterinstitute.ca/people/lucien-hardy.
[126] R. Heyrovska, The Golden ratio, ionic and atomic radii and bond lengths, Molecular Physics, 103 (6-8) (2005) 877-882.
[127] R. Coldea, D. A. Tenant, E. M. Wheeler, E. Wawrzynska, D. Prabhakaran, M. Telling, K. Habicht, P. Smeibidl, and K. Keifer, Quantum Criticality in an Ising chain: Experimental evidence for emergent E8 symmetry, Science 327 (2010) 177-180.
[128] T. A. Chubb and S. R. Chubb, Overcoming the Coulomb Barrier in Cold Fusion, J. Cond. Mat. Nucl. Sci 2 (2009) 51-59.
[129] J. Markloff and A. Strömbergsson, The Boltzmann-Grad limit of the Periodic Lorentz gas, Annals of Mathematics 174 (2011) 225-298.
[130] A. S. Kraemer and D. P. Sanders, Periodizing quasicrystals: Anomalous diffusion in quasiperiodic systems, arXiv: 1206.1103 (2012).
[131] I. Lesanovsky and H. Katsura, Interacting Fibonacci anyons in a Rydberg gas, Phys. Rev A 86 (2012) 041601.
[132] See, e.g., articles on SRI's studies of LENR in the LENR Forum: https://www.lenr-forum.com/forum/index.php/Attachment/549-SRI-pdf/?s=b10e86314a5239b06de77185c5641f585b3160be

What is claimed is:

1. An apparatus for generating power via low energy nuclear reactions (LENR), comprising:
a quasicrystal or quasicrystalline approximant material designed to have an arrangement of atoms, associated with a structure of the quasicrystal or quasicrystalline approximant material, forming active sites for LENR to occur when the material is loaded with a hydrogen isotope.

2. The apparatus of claim 1, wherein the quasicrystal or quasicrystalline approximant material has an arrangement of metal atoms forming active sites for LENR, wherein the metal atoms are organized as atomic clusters of metal atoms.

3. The apparatus of claim 2, wherein a hydrogen isotope gas is loaded into the quasicrystal or quasicryalline approximant material with the hydrogen isotope being a reactant species for LENR at the nuclear active sites via at least one of: 1) hydrogen isotope fusion and 2) metal atom-hydrogen atom fusion.

4. The apparatus of claim 3, wherein the metal atoms comprises palladium and the gas comprises deuterium.

5. The apparatus of claim 1, wherein the material has an energy landscape with a network of double well potentials, with each double well potential having a first well site and a second well site selected for tunneling to occur from an occupied well site to an unoccupied well site of the double well potential.

6. The apparatus of claim 5, wherein each double well potential imposes a restriction on at least one degree of freedom for tunneling of a heavy atom.

7. The apparatus of claim 6, wherein the material has a restriction on a degree of freedom for atomic tunneling including at least one of a spatial restraint, a temporal restraint, and an orientation restraint on degrees of freedom.

8. The apparatus of claim 7, wherein the restriction on the degree of freedom is selected to maximize a negentropy.

9. The apparatus of claim 1, wherein the quasicrystal or quasicrystalline approximant material comprises a guest-host clathrate material having a negentropy at a maximum possible level.

10. The apparatus of claim 1, wherein the material is designed with a guest-host structure to create tautomeric tunneling.

11. The apparatus of claim 1, wherein the material is designed for tunneling phason flips to occur of at least metal atoms as at least a part of the mechanism for LENR.

12. An apparatus for generating power via low energy nuclear reactions (LENR), comprising:
a quasicrystal or quasicrystalline approximant material designed with restrictions on at least one degree of freedom for phason flips to contribute to tunneling of at least one type of atom to active sites for LENR when the material is loaded with a hydrogen isotope.
